(19) United States
(12) Patent Application Publication
(10) Pub. No.: US 2024/0182607 A1
(43) Pub. Date: Jun. 6, 2024

(54) ELECTRO-OPTIC POLYMER

(71) Applicant: Murata Manufacturing Co., Ltd., Nagaokakyo-shi (JP)

(72) Inventor: Ryosuke TAKADA, Nagaokakyo-shi (JP)

(21) Appl. No.: 18/416,307

(22) Filed: Jan. 18, 2024

Related U.S. Application Data
(63) Continuation of application No. PCT/JP2023/007984, filed on Mar. 3, 2023.

(30) Foreign Application Priority Data
Jul. 28, 2022 (JP) 2022-120782

(51) Int. Cl. C08F 32/08; C08F 8/34; C08F 220/36

(52) U.S. Cl. CPC C08F 32/08; C08F 8/34; C08F 220/36

(57) ABSTRACT

An electro-optic polymer includes a backbone that is a polynorbornene chain and an electro-optic structure at a side chain on the backbone. The polynorbornene chain has a first constituent unit represented by:

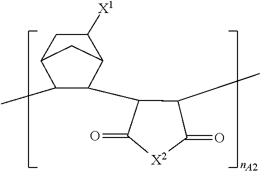

wherein at least one of X¹ or X² is a binding site between the polynorbornene chain and the electro-optic structure, when X¹ is the binding site, X² is —O— or —NH—, when X² is the binding site, X¹ is a hydrogen atom or substituted or unsubstituted alkyl group, and n_{A2} is an integer of 1 or greater.

### CROSS REFERENCE TO RELATED APPLICATIONS

The present application is a continuation of International application No. PCT/JP2023/007984, filed Mar. 3, 2023, which claims priority to Japanese Patent Application No. 2022-120782, filed Jul. 28, 2022, the entire contents of each of which are incorporated herein by reference.

### TECHNICAL FIELD

The present disclosure relates to an electro-optic polymer.

### BACKGROUND ART

Electro-optic polymers are attracting attention as materials that will enable the next generation of, for example, optical communication and wireless communication. Electro-optic polymers are known as optical materials able to produce second-order nonlinear optical effects. The second-order nonlinear optical effects of electro-optic polymers allow for, for example, the conversion of the frequency of electromagnetic waves in various frequency bands and the control of the phase of electromagnetic waves with an electric field.

An example of such an electro-optic polymer is disclosed in Patent Document 1.

Patent Document 1: International Publication No. 2018/003842

### SUMMARY OF THE INVENTION

An example of an application of next-generation optical communication and wireless communication devices is automotive onboard devices for applications such as autonomous driving. Automotive onboard devices are required to have high heat resistance compared with communication devices used in other applications. The level of heat resistance required varies, but an example of a guideline is like that the device should be stable in a continuous use test at 120° C. and withstand temporary use at 150° C. The device also needs to temporarily withstand the temperature of reflow soldering performed during the production of the device (e.g., 260° C.).

In Patent Document 1, too, heat resistance is recognized as an issue in the field of electro-optic polymers; the document argues that electro-optic polymers need to have a high Tg.

To address this, in Patent Document 1, “a polymer comprising (a) a base polymer having a reactive group (A), (b) an electro-optic molecule having a plurality of reactive groups (B), and a bond (C) formed by reaction of the reactive group (A) with the plurality of reactive groups (B), the bond (C) being at least one type of bond selected from the group consisting of a (thio)ester bond, a (thio)urethane bond, a (thio)urea bond and a (thio)amide bond” is proposed.

The heat resistance of this polymer, however, is not sufficient to meet the increasingly demanding high heat resistance requirements in the future. There has been a need for electro-optic polymers with higher heat resistance.

The present disclosure was made to solve the above problem, and an object of it is to provide an electro-optic polymer having high heat resistance.

A first aspect of an electro-optic polymer according to the present disclosure includes a backbone that is a polynorbornene chain and an electro-optic structure at a side chain on the backbone.

A second aspect of the electro-optic polymer according to the present disclosure includes a backbone that is at least one (meth)acrylic chain having a constituent unit represented by general formula (B1) below and an electro-optic structure at a side chain on the backbone, wherein the polymer further has a constituent unit that is represented by general formula (B2) below and that forms a crosslink through copolymerization with a monomer that gives the constituent unit represented by general formula (B1).

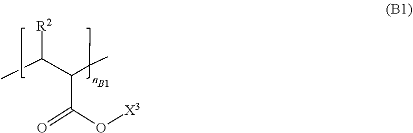

In general formula (B1), X³ is a binding site between the (meth)acrylic chain and the electro-optic structure. R² is a hydrogen atom or methyl group. n_{B1} is an integer of 1 or greater.

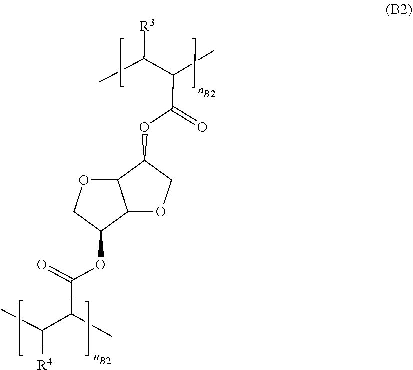

In general formula (B2), R³ and R⁴ are hydrogen atoms or methyl groups. n_{B2} is an integer of 1 or greater.

A third aspect of the electro-optic polymer according to the present disclosure includes a backbone that is a polyimide chain and an electro-optic structure at a side chain on the backbone.

A fourth aspect of the electro-optic polymer according to the present disclosure includes a backbone having at least one triazine ring and an electro-optic structure at a side chain on the backbone.

According to the present disclosure, there can be provided an electro-optic polymer having high heat resistance.

### BRIEF DESCRIPTION OF THE DRAWINGS

FIG. 1 is a perspective schematic view illustrating an optical multilayer body that is an example of a device for which an electro-optic polymer is used.

FIG. 2 is a cross-sectional schematic view illustrating an example of a cross-section along line a1-a2 of the optical multilayer body illustrated in FIG. 1.

### DETAILED DESCRIPTION OF THE PREFERRED EMBODIMENTS

An electro-optic polymer according to the present disclosure will now be described. It should be noted that the present disclosure is not limited to the following configurations and may optionally be modified without departing from the gist of the present disclosure. Combinations of multiple ones of the individual preferred configurations described below are also part of the present disclosure.

In the following, the simple term “the electro-optic polymer according to the present disclosure” is used when the statement is common to all of the first, second, third, and fourth aspects of the electro-optic polymer according to the present disclosure.

Electro-optic polymers according to the present disclosure all have a backbone that is a structure having high heat resistance and an electro-optic structure that is a side chain. Electro-optic polymers according to the present disclosure, furthermore, can all be used for optical communication, wireless communication, and similar devices.

First, as a subject matter common to all aspects, an example of a device for which an electro-optic polymer is used will be described. Then the electro-optic structure will be described. After that, the structure of the backbone and the structure of the entire electro-optic polymer in each aspect will be described separately.

It should be noted that in the description herein, a formula mentioned as a “general formula” may be simply written as “formula.”

### Device for Which an Electro-Optic Polymer is Used

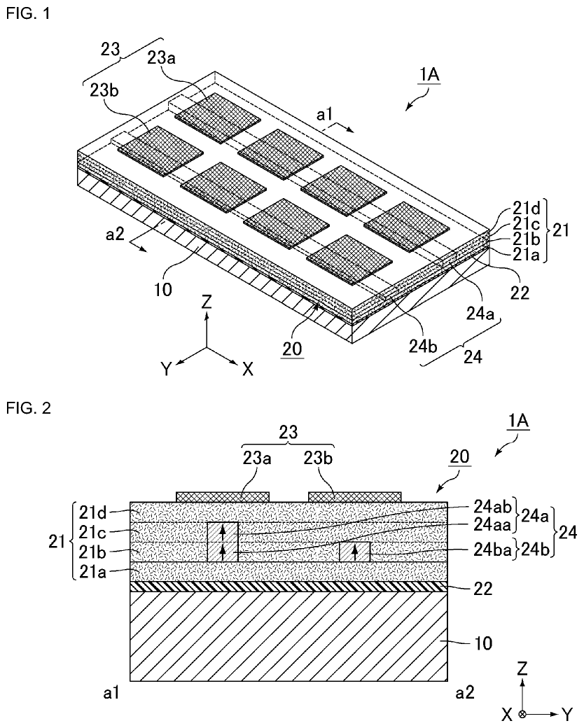

FIG. 1 is a perspective schematic view illustrating an optical multilayer body that is an example of a device for which an electro-optic polymer is used. FIG. 2 is a cross-sectional schematic view illustrating an example of a cross-section along line a1-a2 of the optical multilayer body illustrated in FIG. 1.

The optical multilayer body 1A illustrated in FIGS. 1 and 2 has a support 10 and an electro-optic section 20 in the Z direction (stacking direction).

In the following description, the Z direction is also referred to as the stacking direction Z. It should be noted that the X, Y, and Z directions are perpendicular to each other.

Examples of constituent materials for the support 10 include silicon, glass, polynorbornene, transparent polyimides, (meth)acrylic polymers, cycloolefin polymers, cycloolefin copolymers, and cyanate ester polymers. The support 10 may contain one of such materials alone or may contain multiple ones.

The constituent material for the support 10 is preferably a material with low absorptivity for terahertz radiation for characteristics reasons. It would be good that such a material be a material for which surface smoothness and adhesion can be ensured.

As used herein, terahertz radiation refers to electromagnetic waves in a frequency band of 0.1 THz to 10 THz, both inclusive, and includes microwaves, millimeter waves, infrared light, and other forms of radiation. In the following, terahertz radiation turned into a signal is referred to as a terahertz signal.

The electro-optic section 20 is on a primary surface of the support 10. In other words, the electro-optic section 20 is in contact with the support 10 in the stacking direction Z.

The electro-optic section 20 includes a cladding layer 21, a lower electrode 22, an upper electrode 23, and an electro-optic polymer layer 24.

The cladding layer 21 is provided to prevent electromagnetic waves (e.g., light) traveling through the electro-optic polymer layer 24 from leaking out from an unintended point.

In the example illustrated in FIGS. 1 and 2, the cladding layer 21 is composed of a first cladding layer 21a, a second cladding layer 21b, a third cladding layer 21c, and a fourth cladding layer 21d. The first, second, third, and fourth cladding layers 21a, 21b, 21c, and 21d are stacked in the stacking direction Z, in order from the closest to the support 10.

Examples of constituent materials for the cladding layer 21, or examples of constituent materials for the first, second, third, and fourth cladding layers 21a, 21b, 21c, and 21d in the illustrated example, include silica, silicon dioxide, titanium oxide, and magnesium oxide. Each cladding layer may contain one of such materials alone or may contain multiple ones.

The lower electrode 22 is positioned closer to the support 10 in the stacking direction Z than the cladding layer 21 is. In other words, the lower electrode 22 is between the support 10 and the cladding layer 21 in the stacking direction Z.

In the example illustrated in FIGS. 1 and 2, the lower electrode 22 is between the support 10 and the first cladding layer 21a in the stacking direction Z. The lower electrode 22, furthermore, is in contact with the support 10 and the first cladding layer 21a in the stacking direction Z.

Examples of constituent materials for the lower electrode 22 include gold, silver, copper, tin, chromium, aluminum, and titanium, alloys containing at least one of these metals, and oxides containing at least one of these metals (e.g., indium tin oxide, indium zinc oxide, and aluminum-doped zinc oxide). Of these, materials such as gold, silver, copper, and aluminum are particularly preferred because they are low-loss for the radio frequency, including terahertz radiation. The lower electrode 22 may contain one of such materials alone or may contain multiple ones.

The upper electrode 23 is positioned farther away from the support 10 in the stacking direction Z than the cladding layer 21 is in such a manner that it faces the lower electrode 22 in the stacking direction Z.

In the example illustrated in FIGS. 1 and 2, the upper electrode 23 is in contact with the fourth cladding layer 21d in the stacking direction Z.

In the example illustrated in FIGS. 1 and 2, the upper electrode 23 is composed of first upper electrodes 23a and second upper electrodes 23b. In the example illustrated in FIG. 1, four first upper electrodes 23a and four second upper electrodes 23b are arranged in rows in the X direction, with the two rows side by side in the Y direction. In the example illustrated in FIG. 1, the first upper electrodes 23a are spaced apart from the second upper electrodes 23b in the Y direction. The first upper electrodes 23a, furthermore, are spaced apart from each other in the X direction, and the second upper electrodes 23b are spaced apart from each other in the X direction. As can be seen from these, in the illustrated in FIG. 1, the upper electrode 23 is composed of eight electrodes.

The first and second upper electrodes 23a and 23b are each in contact with the fourth cladding layer 21d in the stacking direction Z.

Examples of constituent materials for the upper electrode 23, or examples of constituent materials for the first and second upper electrodes 23a and 23b in the illustrated example, include gold, silver, copper, tin, chromium, aluminum, and titanium, alloys containing at least one of these metals, and oxides containing at least one of these metals (e.g., indium tin oxide, indium zinc oxide, and aluminum-doped zinc oxide). Of these, materials such as gold, silver, copper, and aluminum are particularly preferred because they are low-loss for the radio frequency, including terahertz radiation. Each upper electrode may contain one of such materials alone or may contain multiple ones.

The electro-optic polymer layer 24 is composed of a first electro-optic polymer layer 24a and a second electro-optic polymer layer 24b.

The first and second electro-optic polymer layers 24a and 24b may be composed solely of a single layer or may be composed of multiple layers.

In the example illustrated in FIG. 2, the first electro-optic polymer layer 24a is composed of a first layer 24aa and a second layer 24ab. The first and second layers 24aa and 24ab are stacked in the stacking direction Z, in order from the closer to the support 10. In other words, the first and second layers 24aa and 24ab are in contact with each other in the stacking direction Z.

In the example illustrated in FIG. 2, furthermore, the second electro-optic polymer layer 24b is composed solely of a first layer 24ba.

The electro-optic polymer layer 24 is made of an electro-optic polymer, which includes an electro-optic structure.

An electro-optic polymer is a polymer able to produce a second-order nonlinear optical effect.

Examples of second-order nonlinear optical effects include second harmonic generation, optical rectification, sum-frequency generation, difference frequency generation, optical parametric oscillation, optical parametric amplification, and an electro-optic effect (the Pockels effect).

In FIG. 2, the direction of polarization of the electro-optic molecules contained in the electro-optic polymer layer 24 is indicated by the direction of the solid arrows.

The production of a second-order nonlinear optical effect by the electro-optic polymer (electro-optic molecules) that forms the electro-optic polymer layer 24 allows for, for example, the conversion of the frequency of electromagnetic waves in various frequency bands or the control of the phase of electromagnetic waves with an electric field. For example, terahertz radiation can be produced by converting the frequencies of a laser beam including two or more frequencies with the second-order nonlinear optical effect. The frequency of a laser beam can be changed by converting the frequencies of a laser beam including one or more frequencies and of terahertz radiation with the second-order nonlinear optical effect, and, furthermore, the terahertz radiation can be detected by detecting the laser beam whose frequency has been changed. With the use of a change in refractive index induced by an electro-optic effect included in second-order nonlinear optical effects, moreover, terahertz radiation and an electric field can be detected. The use of a change in refractive index induced by an electro-optic effect included in second-order nonlinear optical effects also allows for the modulation of the phase of electromagnetic waves.

The optical multilayer body described above can be turned into an optical device by placing an integrated circuit on its upper electrode. The optical multilayer body is used as a converter that converts an optical signal directly into a terahertz signal. The optical multilayer body, furthermore, is also used as a transmitter that transmits a terahertz signal converted from an optical signal to the integrated circuit.

Alternatively, the optical multilayer body described above may be turned into an optical device with a mounted antenna on the upper electrode. The optical multilayer body is used as a converter that converts a terahertz signal received by the antenna directly into an optical signal. The optical multilayer body, furthermore, is also used as a transmitter that transmits an optical signal converted from a terahertz signal to different types of equipment.

### Electro-Optic Structure

Possible structures of the electro-optic structure are the same as those of electro-optic molecules (EO molecules) mentioned in Patent Document 1. An example is a structure represented by a donor structure-a bridge structure-an acceptor structure (structure in which a donor structure and an acceptor structure are bound together with a bridge structure therebetween).

The donor structure is a moiety having an electron-donating group, and examples of electron-donating groups include an alkyl group, an amino group optionally substituted with an aryl or acyl group, an alkoxy group, an aryloxy group, and a thioether group.

The acceptor structure is a moiety having an electron-withdrawing group, and examples of electron-withdrawing groups include a nitro group, a cyano group, a dicyanovinyl group, a tricyanovinyl group, a halogen atom, a carbonyl group, a sulfone group, a perfluoroalkyl group, a tricyanovinylfuranyl, and a tricyanofuranyl group.

The bridge structure is a moiety having a conjugated chemical structure, and examples of conjugated chemical structures include aromatic compounds, such as benzene, naphthalene, anthracene, perylene, biphenyl, indene, and stilbene, heterocyclic compounds, such as furan, pyran, pyrrole, imidazole, pyrazole, thiophene, thiazole, pyridine, pyridazine, pyrimidine, pyrazine, quinoline, and coumarin, and structures in which such compounds have formed a carbon-carbon or nitrogen-nitrogen unsaturated bond.

The electro-optic structure has at least one binding site for the backbone at its end.

The electro-optic structure and the backbone are preferably bound together by at least one binding site formed by at least one selected from the group consisting of a (thio)ester bond, a (thio)urethane bond, a (thio)urea bond, and a (thio)amide bond.

It is preferred that the binding site of the electro-optic structure and at least one binding site of the backbone be bound together to form at least one binding site formed by at least one selected from the group consisting of a (thio)ester bond, a (thio)urethane bond, a (thio)urea bond, and a (thio)amide bond.

A binding site of the electro-optic structure in the electro-optic polymer and a binding site of the backbone, therefore, are the residues of a substituent located at a binding site of the electro-optic molecule from which the electro-optic structure has been derived and of a substituent located at the binding site of the backbone, respectively.

An example of a preferred electro-optic structure is a structure represented by general formula (E-a) below.

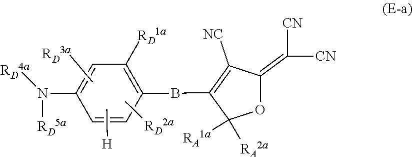

In general formula (E-a), R_{D}^{1a}, R_{D}^{2a}, and R_{D}^{3a} each independently indicate a hydrogen atom, an alkyl group, an alkoxy group, an aryloxy group, an aralkyloxy group, a silyloxy group, an alkenyloxy group, an alkynyloxy group, a hydroxy group, -Rd¹-OH (where Rd¹ is a hydrocarbon group), —ORd²-OH (where Rd² is a hydrocarbon group), —OC(═O)Rd³ (where Rd³ is a hydrocarbon group), an amino group, -Rd⁴-NH₂(where Rd⁴ is a hydrocarbon group), a thiol group, -Rd⁵-SH (where Rd⁵ is a hydrocarbon group), —NCO, or -Rd⁶-NCO (where Rd⁶ is a hydrocarbon group).

At least one of R_{D}^{4a} or R_{D}^{5a} is a structure including a binding site for the backbone and indicates a residue left after an acyloxyalkyl group, a silyloxyalkyl group, -Rd¹-OH (where Rd¹ is a hydrocarbon group), -Rd⁴-NH₂ (where Rd⁴ is a hydrocarbon group), -Rd⁵-SH (where Rd⁵ is a hydrocarbon group), or -Rd⁶-NCO (where Rd⁶ is a hydrocarbon group) binds with a binding site of the backbone.

Of R_{D}^{4a} and R_{D}^{5a}, any structure that is not a binding site for the backbone indicates an alkyl group, a haloalkyl group, an acyloxyalkyl group, a silyloxyalkyl group, -Rd¹-OH (where Rd¹ is a hydrocarbon group), -Rd⁴-NH₂ (where Rd⁴ is a hydrocarbon group), an aryl group, -Rd⁵-SH (where Rd⁵ is a hydrocarbon group), or -Rd⁶-NCO (where Rd⁶ is a hydrocarbon group).

B indicates a linking group, and R_{A}^{1a} and R_{A}^{2a} each independently indicate a hydrogen atom, an alkyl group, an alkenyl group, a cycloalkyl group, a cycloalkenyl group, an alkoxy group, a halogenated hydrocarbon group, an aryl group, a hydroxy group, —Ra¹—OH (where Ra¹ is a hydrocarbon group), —ORa²—OH (where Ra² is a hydrocarbon group), an amino group, —Ra⁴—NH₂ (where Ra⁴ is a hydrocarbon group), a thiol group, —Ra⁵—SH (where Ra⁵ is a hydrocarbon group), —NCO, or —Ra⁶—NCO (where Ra⁶ is a hydrocarbon group).

When R_{A}^{1a} and R_{A}^{2a} are halogenated hydrocarbon groups, the halogens are preferably fluorines, and it is preferred that R_{A}^{1a} and R_{A}^{2a} be trifluoromethyl groups.

At least one of R_{D}^{4a} or R_{D}^{5a} is a structure including a binding site for the backbone and indicates a residue left after binding with a binding site of the backbone.

When the end of the structure including a binding site for the backbone is an OH group, the structure of the residue is an —O— group. When the end of the structure including a binding site for the backbone is an NH₂ group, the structure of the residue is an —NH— group. When the end of R_{D}^{4a} is an SH group, the structure of the residue is a —S— group.

In general formula (E-a), examples of Bs include one forming a conjugated system and one that is a direct bond (—).

An example of a structure forming a conjugated system, for example, is the structure indicated by general formula (B-a) below.

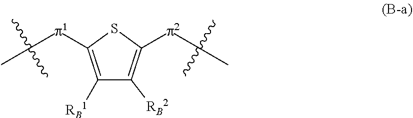

In general formula (B-a), π¹ and π² each independently indicate an identical or different carbon-carbon conjugated π bond and may each have an identical or different substituent; and R_{B}¹ and R_{B}² each independently indicate a hydrogen atom, an alkyl group, an alkoxy group, an aryl group, an alkenyl group, a cycloalkyl group, a cycloalkenyl group, a haloalkyl group, an aralkyl group, an aryloxy group, an aralkyloxy group, a hydroxy group, —Rb¹—OH (where Rb¹ is a hydrocarbon group), —ORb²—OH (where Rb² is a hydrocarbon group), an amino group, —Rb⁴—NH₂ (where Rb⁴ is a hydrocarbon group), a thiol group, —Rb⁵—SH (where Rb⁵ is a hydrocarbon group), —NCO, or —Rb⁶—NCO (where Rb⁶ is a hydrocarbon group) and may each have an identical or different substituent, and R_{B}¹ and R_{B}² may form a ring together with the two carbon atoms to which they are bound.

For the electro-optic structure, furthermore, the position of the binding site for the backbone is not particularly limited.

The position of the binding site can be, for a compound having the structure represented by a donor structure-a bridge structure-an acceptor structure for example, any of the donor structure, the bridge structure, or the acceptor structure. Preferably, the electro-optic structure has two or more binding sites in the donor structure.

For an electro-optic structure represented by general formula (E-a) above, the position of the binding site is not particularly limited. An electro-optic structure represented by general formula (E-a) above may have a binding site at at least two or more of R_{D}^{1a}, R_{D}^{2a}, R_{D}^{3a}, R_{D}^{4a}, R_{D}^{5a}, R_{A}^{1a}, or R_{A}^{2a}, preferably has a binding site at at least two or more of R_{D}^{1a}, R_{D}^{2a}, R_{D}^{3a}, R_{D}^{4a}, or R_{D}^{5a}. It is also preferred that at least one of R_{A}^{1a} or R_{A}^{2a} have a binding site.

An electro-optic structure represented by general formula (E-a), furthermore, may have, as ends of binding sites, two or more residues left after groups selected from the group consisting of an OH group, —R^{B1}—OH, an amino group, and —R^{B4}—NH₂ (where R^{B1} and R^{B4} are hydrocarbon groups) bind with the backbone.

Moreover, it may be that R_{D}^{4a} and/or R_{D}^{5a} is a residue or residues left after a group selected from an OH group, —R^{B1}—OH, an amino group, and —R^{B4}—NH₂ binds with the backbone.

Specific forms having a binding site or sites include forms such as the following.

R_{D}^{4a} and R_{D}^{5a} are binding sites [e.g., the residues of hydroxyalkyl groups (e.g., hydroxy C1-10 alkyl groups, such as hydroxymethyl, hydroxyethyl, hydroxypropyl, or hydroxybutyl groups) or aminoalkyl groups (e.g., amino C₁₋₁₀ alkyl groups, such as aminomethyl, aminoethyl, aminopropyl, or aminobutyl groups)].

When R_{D}^{1a}, R_{D}^{2a}, R_{D}^{3a}, R_{D}^{4a}, R_{D}^{5a}, R_{A}^{1a}, and R_{A}^{2a} are not binding sites (i.e., when they are nonreactive groups), the groups are not particularly limited.

When these are nonreactive groups, specific examples of groups include the following groups.
R_{D}^{1a}: A group such as a hydrogen atom, alkoxy group (e.g., a C₁₋₁₀ alkoxy group, such as a methoxy, ethoxy, or butoxy group), aryloxy group (e.g., a C₆₋₁₀ aryloxy group, such as a phenoxy group), or aralkyloxy group (e.g., a C₆₋₁₀ aryl C₁₋₁₀ alkyloxy group, such as a benzyloxy or phenethyloxy group).
R_{D}^{2a} and R_{D}^{3a}: Groups such as hydrogen atoms.
R_{D}^{4a} and R_{D}^{5a}: Groups such as alkyl groups (e.g., C₁₋₁₀ alkyl groups, such as methyl, ethyl, or butyl groups), aryl groups (e.g., C₆₋₁₀ aryl groups, such as phenyl groups), or aralkyl groups (e.g., C₆₋₁₀ aryl C₁₋₁₀ alkyloxy groups, such as benzyl or phenethyl groups).
R_{A}^{1a} and R_{A}^{2a}: Groups such as alkyl groups (e.g., C₁₋₁₀ alkyl groups, such as methyl, ethyl, or butyl groups), aryl groups (e.g., C₆₋₁₀ aryl groups, such as phenyl groups), cycloalkylaryl groups (e.g., C₃₋₁₀ cycloalkyl C₆₋₁₀ aryl groups, such as cyclohexylphenyl groups), arylaryl groups (e.g., C₆₋₁₀ aryl C₆₋₁₀ aryl groups, such as biphenylyl groups), aralkyl groups (e.g., C₆₋₁₀ aryl C₁₋₁₀ alkyloxy groups, such as benzyl or phenethyl groups), or halogenated hydrocarbon groups [e.g., haloalkyl groups (e.g., halo C₁₋₁₀ alkyl groups, such as trifluoromethyl groups) or haloaryl groups (e.g., halo C₆₋₁₀ aryl groups, such as pentafluorophenyl groups)].

Preferred specific examples of electro-optic molecules used for the formation of an electro-optic structure represented by (E-a) above include the molecules of (E1) to (E4) below. The OH groups located at the left end of formula (E1) to (E3) and the NH₂ group located at the left end of formula (E4) are the ends of binding sites for the backbone. For electro-optic polymers obtained from the electro-optic molecules of formula (E1) to (E3), the structure of the residue or residues is an —O— group. For electro-optic polymers obtained from the electro-optic molecule of formula (E4), the structure of the residue is an —NH— group.

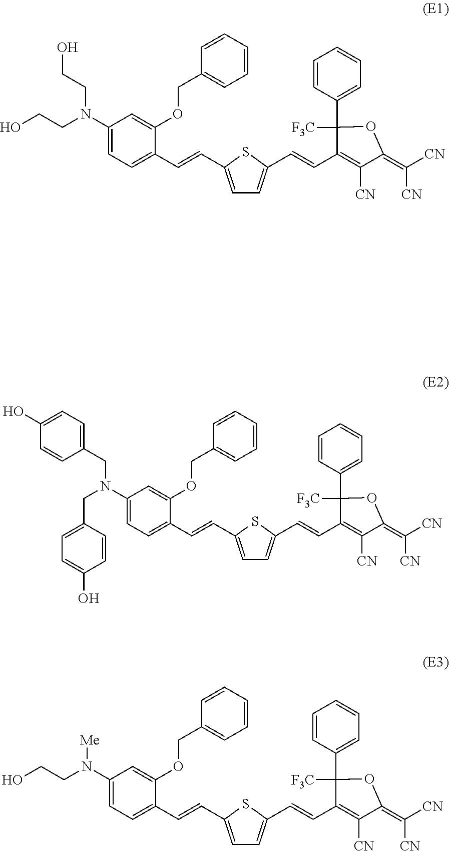

In formula (E3), Me is a methyl group.

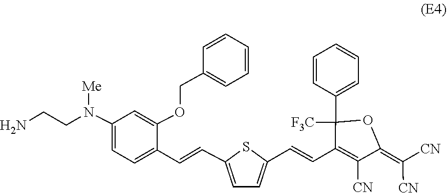

In formula (E4), Me is a methyl group.

An example of a preferred electro-optic structure, furthermore, is a structure represented by general formula (E-b) below.

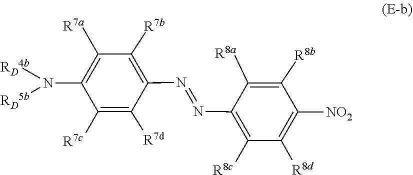

In general formula (E-b), at least one of R_{D}^{4b}, R_{D}^{5b}, R^{7a}, R^{7b}, R^{7c}, R^{7d}, R^{8a}, R^{8b}, R^{8c}, or R^{8d} is a structure including a binding site for the backbone.

Structures including a binding site for the backbone each independently indicate a residue left after a hydroxy group, -Rd¹-OH (where Rd¹ is a hydrocarbon group), an amino group, -Rd⁴-NH₂ (where Rd⁴ is a hydrocarbon group), a thiol group, -Rd⁵-SH (where Rd⁵ is a hydrocarbon group), —NCO, or -Rd⁶-NCO (where Rd⁶ is a hydrocarbon group) binds with a binding site of the backbone.

Each of structures that are not binding sites for the backbone is independently a hydrogen atom, a hydrocarbon group, a hydroxy group, -Rd¹-OH (where Rd¹ is a hydrocarbon group), an amino group, -Rd⁴-NH₂ (where Rd⁴ is a hydrocarbon group), a thiol group, -Rd⁵-SH (where Rd⁵ is a hydrocarbon group), —NCO, or -Rd⁶-NCO (where Rd⁶ is a hydrocarbon group).

For structures represented by general formula (E-b), a structure in which at least two of R_{D}^{4b}, R_{D}^{5b}, R^{7a}, R^{7b}, R^{7c}, R^{7d}, R^{8a}, R^{8b}, R^{8c}, or R^{8d} are hydroxy groups, -Rd¹-OH (where Rd¹ is a hydrocarbon group), amino groups, -Rd⁴-NH₂ (where Rd⁴ is a hydrocarbon group), thiol groups, -Rd⁵-SH (where Rd⁵ is a hydrocarbon group), —NCO, or -Rd⁶-NCO (where Rd⁶ is a hydrocarbon group) or the residues of these groups is also an example of a preferred structure.

For R_{D}^{4b}, R_{D}^{5b}, R^{7a}, R^{7b}, R^{7c}, R^{7d}, R^{8a}, R^{8b}, R^{8c}, and R^{8d}, examples of hydrocarbon groups include aliphatic groups [e.g., C₁₋₁₀ alkyl groups (e.g., a methyl group, an ethyl group, a propyl group, and a butyl group) and C₂₋₁₀ alkenyl groups (e.g., an ethenyl group, a propenyl group, and a butenyl group), preferably C₁₋₆ alkyl groups and C₂₋₆ alkenyl groups], alicyclic groups [e.g., C₃₋₁₂ cycloalkyl groups (e.g., a cyclopropyl group, a cyclobutyl group, a cyclopentyl group, and a cyclohexyl group), preferably C₃₋₇ cycloalkyl groups], and aromatic groups {e.g., C₆₋₂₀ aromatic groups [e.g., C₆₋₂₀ aryl groups (e.g., a phenyl group, a tolyl group, a xylyl group, and a naphthyl group) and C₇₋₂₀ aralkyl groups (e.g., a benzyl group)]}. Of these, aliphatic groups are particularly preferred, and C₁₋₁₀ alkyl groups are particularly preferred.

The electro-optic structure preferably includes at least a structure represented by general formula (E-a) above.

When the electro-optic structure is a combination of a structure represented by general formula (E-a) above and a structure represented by general formula (E-b), the ratio by weight of the structure represented by general formula (E-a)/the structure represented by general formula (E-b) is from 3/1 to 1/1 for example, preferably from 2/1 to 1/1.

As for the molar ratio of the structure represented by general formula (E-a)/the structure represented by general formula (E-b), it is from 3/1 to 1/1 for example, preferably from 2/1 to 1/1.

By using a structure represented by general formula (E-a) above in combination with a structure represented by general formula (E-b) for the electro-optic structure, the refractive index and the electro-optic constant can be increased without reducing the resistivity of the electro-optic polymer, compared with when the percentage of the electro-optic structure in the electro-optic polymer is increased with a structure represented by general formula (E-a) alone.

The compound or compounds that give the electro-optic structure can be produced by methods known in themselves.

For example, the compound or compounds that give the electro-optic structure can be produced by various methods such as the methods described in Ann., 580, 44 (1953), Angew. Chem., 92, 671 (1980), Chem. Ber., 95, 581 (1962), Macromolecules, 2001, 34, 253, Chem. Mater., 2007, 19, 1154, Org. Synth., VI, 901 (1980), Chem. Mater., 2002, 14, 2393, J. Mater. Sci., 39, 2335 (2004), “Preparative Organic Chemistry,” John Wiley (1975), p. 217, J. Org. Chem., 42, 353 (1977), J. Org. Chem., 33, 3382 (1968), Synthesis, 1981, 165, International Publication No. 2011/024774, etc., versions of such methods with appropriate modifications, and combinations of such methods. The introduction of the binding site may be performed in the process for producing the compound or compounds that give the electro-optic structure.

### Backbone Structure in a First Aspect of the Electro-Optic Polymer

A first aspect of the electro-optic polymer according to the present disclosure includes a backbone that is a polynorbornene chain and an electro-optic structure at a side chain on the backbone.

A polynorbornene chain is a molecular structure with high heat resistance (a high Tg). By using a polynorbornene chain as the backbone of an electro-optic polymer, therefore, an electro-optic polymer with high heat resistance can be obtained.

It is preferred that the backbone that is a polynorbornene chain and the electro-optic structure be bound together by at least one binding site formed by at least one selected from the group consisting of a (thio)ester bond, a (thio)urethane bond, a (thio)urea bond, and a (thio)amide bond.

It is preferred that the polynorbornene chain have a constituent unit represented by general formula (A1) below.

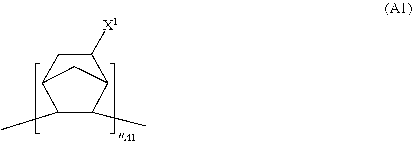

In general formula (A1), X¹ is a binding site between the polynorbornene chain and the electro-optic structure. n_{A1} is an integer of 1 or greater.

X¹ is preferably the residue of a substituent that produces a binding site formed by at least one selected from the group consisting of a (thio)ester bond, a (thio)urethane bond, a (thio)urea bond, and a (thio)amide bond together with a substituent located at a binding site of the electro-optic structure.

X¹ is, for example, a residue left after the end of —COO—R—NCO, —COO—R—NHCOOR¹, —R—COOR¹, —COOR¹, —R—COOH, or COOH binds with a binding site of the electro-optic structure.

R is a substituted or unsubstituted alkylene group. Examples of substituents include a halogen, an alkyl group, and an aryl group. The number of carbon atoms in the alkylene group is not limited, but preferably is two or more and eight or fewer, more preferably two or three, even more preferably two.

R¹ is a substituted or unsubstituted alkyl group. The number of carbon atoms in the alkyl group is preferably from one to ten. The alkyl group may be a linear chain or may be a branched chain, and examples of substituents include a halogen and an aryl group.

The number of carbon atoms in the R¹ alkyl group is preferably one or more and twelve or fewer, more preferably one or more and four or fewer.

Specific examples include a methyl group, an ethyl group, a propyl group, an isopropyl group, an n-butyl group, an i-butyl group, a t-butyl group, an n-pentyl group, an n-hexyl group, an n-heptyl group, an n-octyl group, and a 2-ethylhexyl group. Preferably, R¹ is a methyl group.

It is, therefore, preferred that R be an ethylene group and R¹ be a methyl group, and X¹ is preferably a residue left after the end of —COO—C₂H₄—NCO, —COO—C₂H₄—NHCOOCH₃, —C₂H₄—COOCH₃, or —C₂H₄—COOH binds with a binding site of the electro-optic structure.

When the structure of X¹ before binding with the electro-optic structure is —COO—R—NCO or —COO—R—NHCOOR¹, the NCO end or NHCOOR¹ end produces a (thio)urethane bond by reacting with an OH group at a binding site of the electro-optic structure. In that case, X¹ is a residue left after a (thio)urethane bond is formed through reaction with an OH group at a binding site of the electro-optic structure.

When X¹ is the residue of —R—COOR¹, —COOR¹, —R—COOH, or —COOH, the COOR¹ end or COOH end is the binding site for the electro-optic structure, and X¹ may be a residue left after a (thio)ester bond is formed through reaction with an OH group at a binding site of the electro-optic structure. When X¹ is the residue of —R—COOR¹, —COOR¹, —R—COOH, or —COOH, furthermore, X¹ may be a residue left after a (thio)amide bond is formed through reaction with an NH₂ group at a binding site of the electro-optic structure.

The polynorbornene chain may have a constituent unit represented by general formula (A1) above alone. It may be that, furthermore, the electro-optic structure is bound to the end of multiple X¹s, and it may be that the electro-optic structure is bound to only a subset of multiple X¹s.

The structure of multiple X¹s, furthermore, may be totally the same or may be partially different.

It is preferred that the polynorbornene chain have a constituent unit represented by general formula (A2) below.

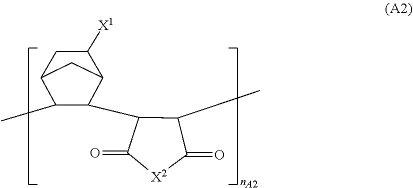

In general formula (A2), at least one of X¹ or X² is a binding site between the polynorbornene chain and the electro-optic structure. When X¹ is a binding site, X² may be —O— or —NH— rather than a binding site. When X² is a binding site, X¹ may be a hydrogen atom or substituted or unsubstituted alkyl group. n_{A2} is an integer of 1 or greater.

In the case of general formula (A2), too, it is preferred that X¹ when X¹ is a binding site be the residue of a substituent that produces a binding site formed by at least one selected from the group consisting of a (thio)ester bond, a (thio)urethane bond, a (thio)urea bond, and a (thio)amide bond together with a substituent located at a binding site of the electro-optic structure, as in the case of general formula (A1).

X¹ when X¹ is a binding site is preferably a residue left after, for example, the end of —COO—R—NCO, —COO—R—NHCOOR¹, —R—COOR¹, —COOR¹, —R—COOH, or COOH binds with a binding site of the electro-optic structure.

X² when X² is a binding site, furthermore, is preferably the residue of a substituent that produces a binding site formed by at least one selected from the group consisting of an imide bond, a (thio)ester bond, a (thio)urethane bond, a (thio)urea bond, and a (thio)amide bond together with a substituent located at a binding site of the electro-optic structure.

X² is preferably a residue left after, for example, the end of —N(—)—, —CH(—)—COO—R—NCO, —CH(—)—COO—R—NHCOOR¹, —CH(—)—R—COOR¹, —CH(—)—COOR¹, —CH(—)—R—COOH, —CH(—)—COOH, —N(—)—COO—R—NCO, —N(—)—COO—R—NHCOOR¹, —N(—)—R—COOR¹, —N(—)—COOR¹, —N(—)—R—COOH, or —N(—)—COOH binds with a binding site of the electro-optic structure.

When X² is the residue of an imide bond, X² is —N(—)—. When the starting structure for X² is a maleic anhydride group and it is imidized with an NH₂ group at an end of an electro-optic molecule, the resulting X² is the residue of an imide bond.

For R and R¹ included in X¹ and X² in general formula (A2), possible structures are the same as the structures mentioned by way of example for R and R¹ included in X¹ in general formula (A1). The structure of multiple X¹s and X²s, furthermore, may be totally the same or may be partially different.

When the end of the structure of X¹ or X² before binding with the electro-optic structure is an NCO end or NHCOOR¹ end, it produces a (thio)urethane bond by reacting with an OH group at a binding site of the electro-optic structure. In that case, the X¹ or X² is a residue left after a (thio)urethane bond is formed through reaction with an OH group at a binding site of the electro-optic structure.

When the end of the structure of X¹ or X² before binding with the electro-optic structure is a COOR¹ end or COOH end, furthermore, the X¹ or X² may be a residue left after a (thio)ester bond is formed through reaction with an OH group at a binding site of the electro-optic structure.

When the end of the structure of X¹ or X² before binding with the electro-optic structure is a COOR¹ end or COOH end, moreover, the X¹ or X² may be a residue left after a (thio)amide bond is formed through reaction with an NH₂ group at a binding site of the electro-optic structure.

The polynorbornene chain may have a constituent unit represented by general formula (A2) above alone. It may be that, furthermore, the electro-optic structure is bound to the end of multiple X¹s and X²s, and it may be that the electro-optic structure is bound to only a subset of multiple X¹s and X²s.

The structure of multiple X¹s and X²s, furthermore, may be totally the same or may be partially different.

It may be that the polynorbornene chain is a copolymer having a constituent unit represented by general formula (A1) above and a constituent unit represented by general formula (A2) above. The constitutional percentages of the constituent unit represented by general formula (A1) and the constituent unit represented by general formula (A2) in that case are not particularly limited.

Preferably, the polynorbornene chain further has a constituent unit represented by general formula (A3) below besides a constituent unit represented by general formula (A1) or (A2) above.

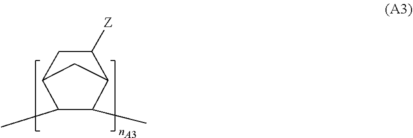

In general formula (A3), Z is a hydrogen atom or substituted or unsubstituted alkyl group. n_{A3} is an integer of 1 or greater.

Z in general formula (A3) is a substituted or unsubstituted alkyl group. The alkyl group may be a linear chain or may be a branched chain, and examples of substituents include a halogen and an aryl group. It should be noted that Z is not a binding site for the electro-optic structure; therefore, it is preferred that Z have no active-hydrogen-containing substituent (e.g., OH, NH₂, NCO, COOH, or SH group), which can make the group a binding site.

The number of carbon atoms in the Z alkyl group is preferably one or more and twelve or fewer, more preferably four or more and eight or fewer.

Specific examples include a methyl group, an ethyl group, a propyl group, an isopropyl group, an n-butyl group, an i-butyl group, a t-butyl group, an n-pentyl group, an n-hexyl group, an n-heptyl group, an n-octyl group, and a 2-ethylhexyl group. Of these, it is preferred that Z be an n-butyl or 2-ethylhexyl group.

The presence of a constituent unit represented by general formula (A3) allows for the adjustment of physical characteristics of the electro-optic polymer. An electro-optic polymer with a polynorbornene chain having a constituent unit represented by general formula (A1) or (A2) alone can be a material that is rigid and difficult to handle. The presence of a constituent unit represented by general formula (A3) in the polynorbornene chain makes the electro-optic polymer a flexible material, making it a material that is easy to handle.

The polynorbornene chain preferably has a constituent unit represented by general formula (A1) above and a constituent unit represented by general formula (A3) above. The ratio (molar ratio) between the constituent unit represented by general formula (A1) and the constituent unit represented by general formula (A3) in that case is not particularly limited, but for example, it may be that (A1):(A3)=1:1. The ratio may be 1:2 or may be 2:1.

Specific examples for when the polynorbornene chain has a constituent unit represented by general formula (A1) above and a constituent unit represented by general formula (A3) above include structures such as the following.

The polymerizable portion [ ]n_{A1} of the constituent unit represented by general formula (A1) and the polymerizable portion [ ]n_{A3} of the constituent unit represented by general formula (A3) may be in block polymerization or may be in random polymerization.

For the electro-optic molecule from which the electro-optic structure has been derived, the structures presented by way of example are ones in which the molecule of formula (E3) or (E4) is used.

An example for when the end of the binding site before binding with the electro-optic structure is an NCO group or NHCOOR¹ group and when the electro-optic molecule from which the electro-optic structure has been derived is the molecule of formula (E3) is presented below. The binding site is a urethane bond.

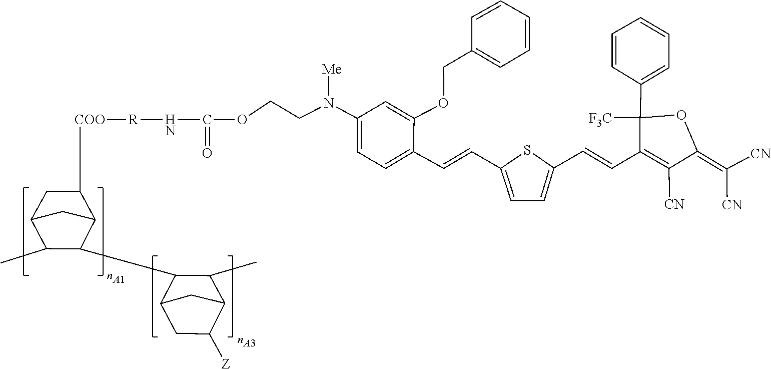

An example for when the end of the binding site before binding with the electro-optic structure is a COOR¹ group or COOH group and when the electro-optic molecule from which the electro-optic structure has been derived is the molecule of formula (E4) is presented below. The binding site is an amide bond.

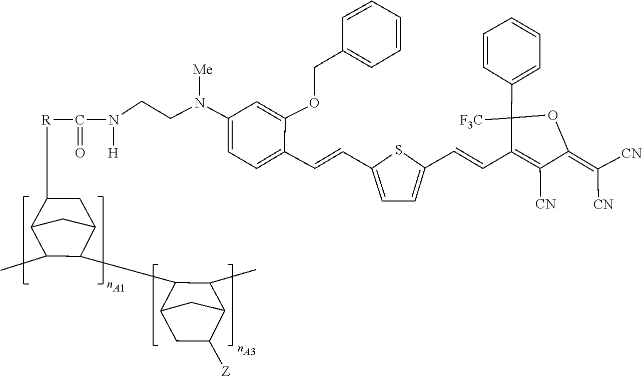

The polynorbornene chain preferably has a constituent unit represented by general formula (A2) above and a constituent unit represented by general formula (A3) above. The ratio (molar ratio) between the constituent unit represented by general formula (A2) and the constituent unit represented by general formula (A3) in that case is not particularly limited, but for example, it may be that (A2):(A3)=1:1. The ratio may be 1:2 or may be 2:1. Preferably, (A2):(A3)=1:1.

Specific examples of electro-optic polymers for when the polynorbornene chain has a constituent unit represented by general formula (A2) above and a constituent unit represented by general formula (A3) above include structures such as the following.

The polymerizable portion [ ]n_{A2} of the constituent unit represented by general formula (A2) and the polymerizable portion [ ]n_{A3} of the constituent unit represented by general formula (A3) may be in block polymerization or may be in random polymerization.

For the electro-optic molecule from which the electro-optic structure has been derived, the structures presented by way of example are ones in which the molecule of formula (E3) or (E4) is used.

An example for when the end of the binding site before binding with the electro-optic structure is an NCO group or NHCOOR¹ group and when the electro-optic molecule from which the electro-optic structure has been derived is the molecule of formula (E3) is presented below. The binding site is a urethane bond. This is an example in which X² is —O— rather than a binding site.

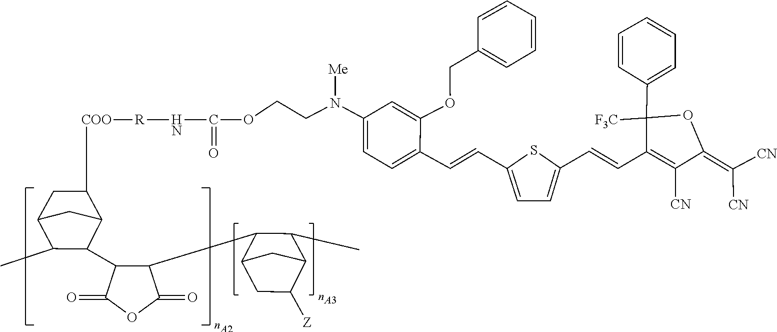

An example for when the end of the binding site before binding with the electro-optic structure is a COOR¹ group or COOH group and when the electro-optic molecule from which the electro-optic structure has been derived is the molecule of formula (E4) is presented below. The binding site is an amide bond. This is an example in which X² is —O— rather than a binding site.

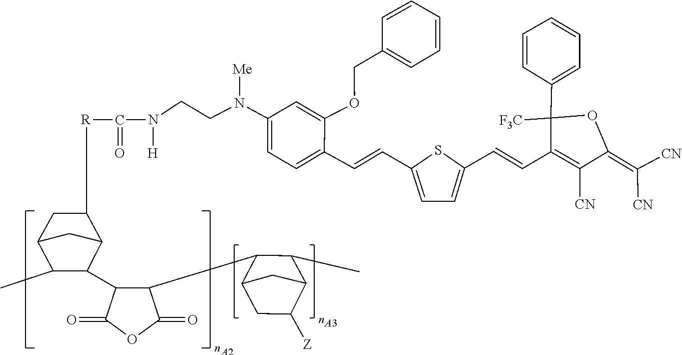

The polynorbornene chain preferably has a constituent unit represented by general formula (A1) above, a constituent unit represented by general formula (A2) above, and a constituent unit represented by general formula (A3) above. The ratio (molar ratio) between the constituent unit represented by general formula (A1), the constituent unit represented by general formula (A2), and the constituent unit represented by general formula (A3) in that case is not particularly limited, but for example, it may be that (A1):(A2):(A3)=1:1:1.

Specific examples for when the polynorbornene chain has a constituent unit represented by general formula (A1) above, a constituent unit represented by general formula (A2) above, and a constituent unit represented by general formula (A3) above include structures such as the following.

The polymerizable portion [ ]n_{A1} of the constituent unit represented by general formula (A1), the polymerizable portion [ ]n_{A2} of the constituent unit represented by general formula (A2), and the polymerizable portion [ ]n_{A3} of the constituent unit represented by general formula (A3) may be in block polymerization or may be in random polymerization.

For the electro-optic molecule from which the electro-optic structure has been derived, the structures presented by way of example are ones in which the molecule of formula (E3) or (E4) is used.

An example for when the end of the binding site before binding with the electro-optic structure is an NCO group or NHCOOR¹ group and when the electro-optic molecule from which the electro-optic structure has been derived is the molecule of formula (E3) is presented below. The binding site is urethane bonds. This is an example in which X² is —O— rather than a binding site.

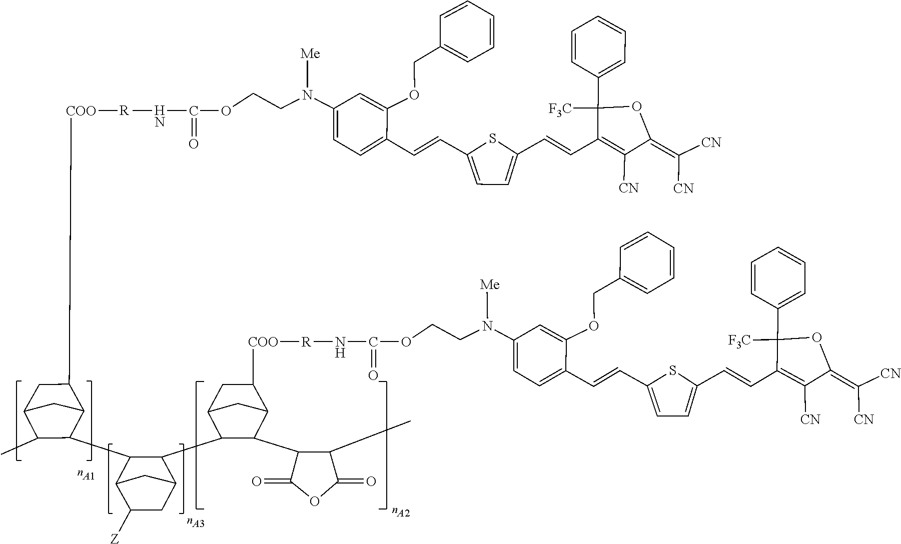

An example for when the end of the binding site before binding with the electro-optic structure is a COOR¹ group or COOH group and when the electro-optic molecule from which the electro-optic structure has been derived is the molecule of formula (E4) is presented below. The binding site is amide bonds. This is an example in which X² is —O— rather than a binding site.

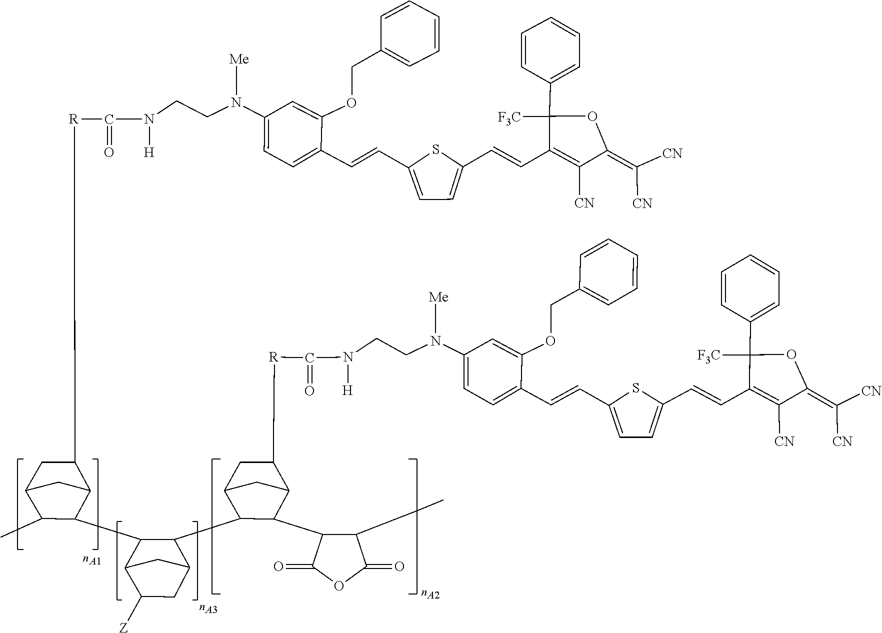

For the electro-optic polymer according to the first aspect, it is preferred that its glass transition temperature (hereinafter also referred to as Tg) be 210° C. or above, more preferably 230° C. or above, even more preferably 250° C. or above. When the Tg is 210° C. or above, the electro-optic polymer can be deemed to be one having sufficiently high heat resistance.

The Tg of an electro-optic polymer herein can be determined by measuring it using a differential scanning calorimeter (Rigaku Thermo plus DSC 8230, manufactured by Rigaku Corporation) under the following conditions: the measurement sample, 10 mg; the reference sample, an Al blank cell; atmosphere, nitrogen; the temperature elevation rate, 10° C./min.

The electro-optic polymer according to the first aspect can be manufactured by the following procedure.
(1) Production of a norbornene monomer having the binding site
(2) Production of the polynorbornene chain
(3) Introduction of the electro-optic structure
   (1) Production of a Norbornene Monomer Having a Substituent X¹′ that Gives the Binding Site

An ethylene derivative having a substituent X¹′ and cyclopentadiene are subjected to a Diels-Alder reaction, and a norbornene monomer is produced through the reaction indicated below.

The substituent X¹′ is the structure of X¹ before binding with the electro-optic structure.

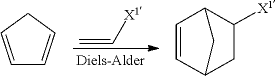

### (2) Production of the Polynorbornene Chain

The norbornene monomer obtained in (1) is polymerized to give a polynorbornene chain.

Optionally, a monomer that gives a constituent unit represented by general formula (A1), a monomer that gives a constituent unit represented by general formula (A2), and/or a monomer that gives a constituent unit represented by general formula (A3) are mixed and polymerized together.

Presented below is an example in which a monomer that gives a constituent unit represented by general formula (A1) and a monomer that gives a constituent unit represented by general formula (A3) are polymerized together.

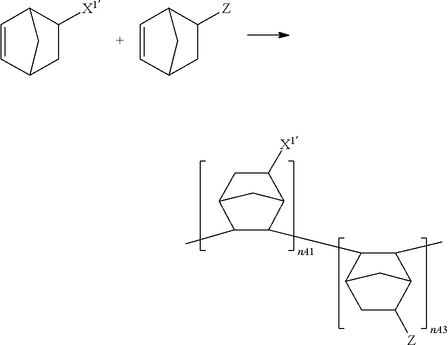

### (3) Introduction of the Electro-Optic Structure

Examples include the method of allowing the polynorbornene chain obtained in (2) and an electro-optic molecule that gives the electro-optic structure to react together in the presence of a solvent. The reaction may be performed under conditions such as under heat (e.g., at an internal temperature of 50° C. to 100° C.). The reaction, furthermore, may be performed in the presence of a catalyst.

Through this procedure, an electro-optic polymer including a backbone that is a polynorbornene chain and an electro-optic structure at a side chain on the backbone can be obtained.

### Backbone Structure in a Second Aspect of the Electro-Optic Polymer

A second aspect of the electro-optic polymer according to the present disclosure includes a backbone that is at least one (meth)acrylic chain having a constituent unit represented by general formula (B1) below and an electro-optic structure at a side chain on the backbone. The polymer further has a constituent unit that is represented by general formula (B2) below and that forms a crosslink through copolymerization with a monomer that gives the constituent unit represented by general formula (B1).

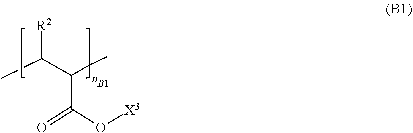

[In general formula (B1), X³ is a binding site between the (meth)acrylic chain and the electro-optic structure. R² is a hydrogen atom or methyl group. n_{B1} is an integer of 1 or greater.]

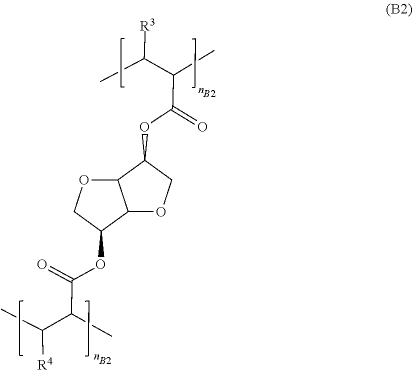

In general formula (B2), R³ and R⁴ are hydrogen atoms or methyl groups. n_{B2} is an integer of 1 or greater.

As used herein, (meth)acrylic chain refers to an acrylic chain or methacrylic chain. (Meth)acrylate, furthermore, refers to an acrylate (acrylic acid ester) or methacrylate (methacrylic acid ester).

By virtue of the structure indicated by general formula (B2), the backbone of the second aspect of the electro-optic polymer is in a crosslinked structure in which the (meth)acrylic chain is crosslinked at the crosslink. The presence of the crosslink makes the molecular structure one having high heat resistance. This allows an electro-optic polymer with high heat resistance to be obtained.

It is preferred that the backbone that is at least one (meth)acrylic chain and the electro-optic structure be bound together by at least one binding site formed by at least one selected from the group consisting of a (thio)ester bond, a (thio)urethane bond, a (thio)urea bond, and a (thio)amide bond.

X³ is preferably the residue of a substituent that produces a binding site formed by at least one selected from the group consisting of a (thio)ester bond, a (thio)urethane bond, a (thio)urea bond, and a (thio)amide bond together with a substituent located at a binding site of the electro-optic structure.

For example, it is preferred that X³ be a residue left after the end of a hydrogen atom, —R—NCO, —R—NHCOOR¹, —R—COOR¹, —COOR¹, —R—COOH, or COOH binds with a binding site of the electro-optic structure.

R is a substituted or unsubstituted alkylene group. Examples of substituents include a halogen, an alkyl group, and an aryl group. The number of carbon atoms in the alkylene group is not limited, but preferably is two or more and eight or fewer, more preferably two or three, even more preferably two.

R¹ is a substituted or unsubstituted alkyl group. The number of carbon atoms in the alkyl group is preferably from one to ten. The alkyl group may be a linear chain or may be a branched chain, and examples of substituents include a halogen and an aryl group.

The number of carbon atoms in the R¹ alkyl group is preferably one or more and twelve or fewer, more preferably one or more and four or fewer.

Specific examples include a methyl group, an ethyl group, a propyl group, an isopropyl group, an n-butyl group, an i-butyl group, a t-butyl group, an n-pentyl group, an n-hexyl group, an n-heptyl group, an n-octyl group, and a 2-ethylhexyl group. Preferably, R¹ is a methyl group.

It is, therefore, preferred that R be an ethylene group and R¹ be a methyl group, and X³ is preferably a residue left after the end of —C₂H₄—NCO, —C₂H₄—NHCOOCH₃, —C₂H₄—COOCH₃, or —C₂H₄—COOH binds with a binding site of the electro-optic structure.

R² in general formula (B1) is a hydrogen atom or methyl group, preferably a methyl group.

An example of a monomer that gives a constituent unit represented by general formula (B1) is 2-isocyanatoethyl (meth)acrylate, which is indicated by general formula (B1-a) below (for trade names, an example is Karenz® MOI or AOI (manufactured by Resonac Corporation)).

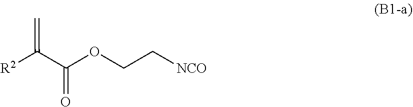

R³ and R⁴ in general formula (B2) are hydrogen atoms or methyl groups, preferably methyl groups.

An example of a monomer that gives a constituent unit represented by general formula (B2) is isosorbide (meth)acrylate.

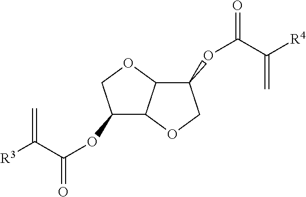

The backbone has a constituent unit represented by general formula (B1) and a constituent unit represented by general formula (B2). The ratio (molar ratio) between the constituent unit represented by general formula (B1) and the constituent unit represented by general formula (B2) is not particularly limited, but for example, it may be that (B1):(B2)=1:1. The ratio may be 1:2 or may be 2:1.

Specific examples of electro-optic polymers having a constituent unit represented by general formula (B1) and a constituent unit represented by general formula (B2) include structures such as the following.

The polymerizable portion [ ]n_{B1} of the constituent unit represented by general formula (B1) and the polymerizable portion [ ]n_{B2} of the constituent unit represented by general formula (B2) may be in block polymerization or may be in random polymerization.

An example for when the end of the binding site before binding with the electro-optic structure is an NCO group or NHCOOR¹ group and when the electro-optic molecule from which the electro-optic structure has been derived is the molecule of formula (E3) is presented below. The binding site is urethane bonds.

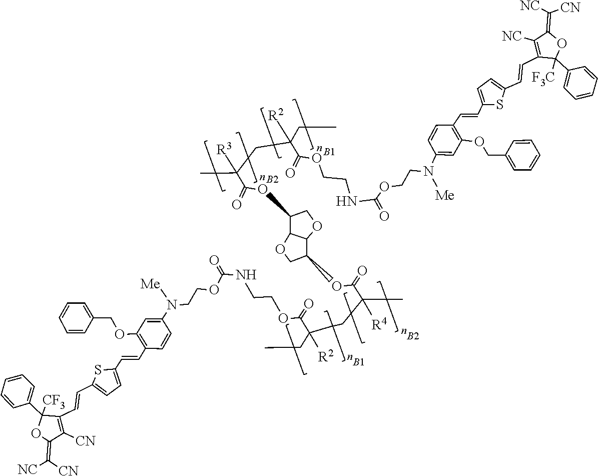

Preferably, the backbone further has a constituent unit represented by general formula (B3) below.

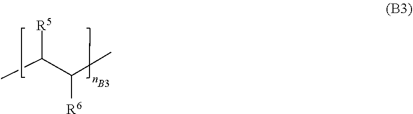

In general formula (B3), R⁵ is a hydrogen atom or methyl group, and R⁶ is a hydrogen atom, substituted or unsubstituted alkyl group, —COOR⁷ group, or —COO—R⁸—NHCOOR⁹ group. Each of R⁷ and R⁹ is independently a substituted or unsubstituted alkyl group. R⁸ is a substituted or unsubstituted alkylene group. n_{B3} is an integer of 1 or greater.

R⁵ in general formula (B3) is a hydrogen atom or methyl group, preferably a methyl group.

R⁶ in general formula (B3) is a hydrogen atom, substituted or unsubstituted alkyl group, —COOR⁷ group, or —COO—R⁸—NHCOOR⁹ group. When R⁶ is a substituted or unsubstituted alkyl group, the alkyl group may be a linear chain or may be a branched chain, and examples of substituents include a halogen and an aryl group. It should be noted that R⁶ is not a binding site for the electro-optic structure; therefore, it is preferred that R⁶ have no active-hydrogen-containing substituent (e.g., OH, NH₂, NCO, COOH, or SH group), which can make the group a binding site.

The number of carbon atoms in an R⁶ alkyl group is preferably one or more and twelve or fewer, more preferably one or more and four or fewer.

Specific examples include a methyl group, an ethyl group, a propyl group, an isopropyl group, an n-butyl group, an i-butyl group, a t-butyl group, an n-pentyl group, an n-hexyl group, an n-heptyl group, an n-octyl group, and a 2-ethylhexyl group. R⁶ when R⁶ is a substituted or unsubstituted alkyl group is preferably a methyl group.

R⁸ is a substituted or unsubstituted alkylene group. Examples of substituents include a halogen, an alkyl group, and an aryl group. The number of carbon atoms in the alkylene group is not limited, but preferably is two or more and eight or fewer, more preferably two or three, even more preferably two.

Each of R⁷ and R⁹ is independently a substituted or unsubstituted alkyl group. The alkyl group may be a linear chain or may be a branched chain, and examples of substituents include a halogen and an aryl group. It should be noted that R⁷ and R⁹ are not binding sites for the electro-optic structure; therefore, it is preferred that R⁷ and R⁹ have no active-hydrogen-containing substituent (e.g., OH, NH₂, NCO, COOH, or SH group), which can make the groups binding sites.

The number of carbon atoms in the R⁷ and R⁹ alkyl groups is preferably one or more and twelve or fewer, more preferably one or more and four or fewer.

Specific examples include a methyl group, an ethyl group, a propyl group, an isopropyl group, an n-butyl group, an i-butyl group, a t-butyl group, an n-pentyl group, an n-hexyl group, an n-heptyl group, an n-octyl group, and a 2-ethylhexyl group. Preferably, R⁷ and R⁹ are methyl groups.

R⁶ when R⁶ is a —COO—R⁸—NHCOOR⁹ group is preferably —COO—C₂H₄—NHCOOCH₃.

The presence of a constituent unit represented by general formula (B3) allows for the adjustment of physical characteristics of the electro-optic polymer. An electro-optic polymer having a constituent unit represented by general formula (B1) or (B2) alone can be a material that is rigid and difficult to handle. Adding a constituent unit represented by general formula (B3) makes the electro-optic polymer a flexible material, making it a material that is easy to handle.

An example of a monomer that gives a constituent unit represented by general formula (B3) is an alkyl carbamate derivative, which is indicated by general formula (B3-a) below, of 2-isocyanatoethyl (meth)acrylate.

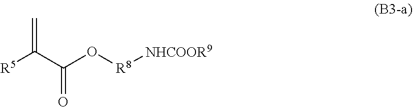

In general formula (B3-a), R⁵ is a hydrogen atom or methyl group, R⁸ is a substituted or unsubstituted alkylene group, and R⁹ is a substituted or unsubstituted alkyl group.

The backbone preferably has a constituent unit represented by general formula (B1), a constituent unit represented by general formula (B2), and a constituent unit represented by general formula (B3). The ratio (molar ratio) between the constituent unit represented by general formula (B1), the constituent unit represented by general formula (B2), and the constituent unit represented by general formula (B3) in that case is not particularly limited, but for example, it may be that (B1):(B2):(B3)=1:1:1, or it may be that (B1):(B2):(B3)=1:2:1.

Specific examples of electro-optic polymers for when the backbone has a constituent unit represented by general formula (B1), a constituent unit represented by general formula (B2), and a constituent unit represented by general formula (B3) include structures such as the following.

The polymerizable portion [ ]n_{B1} of the constituent unit represented by general formula (B1), the polymerizable portion [ ]n_{B2} of the constituent unit represented by general formula (B2), and the polymerizable portion [ ]n_{B3} of the constituent unit represented by general formula (B3) may be in block polymerization or may be in random polymerization.

An example for when the end of the binding site before binding with the electro-optic structure is an NCO group or NHCOOR¹ group and when the electro-optic molecule from which the electro-optic structure has been derived is the molecule of formula (E3) is presented below. The binding site is urethane bonds.

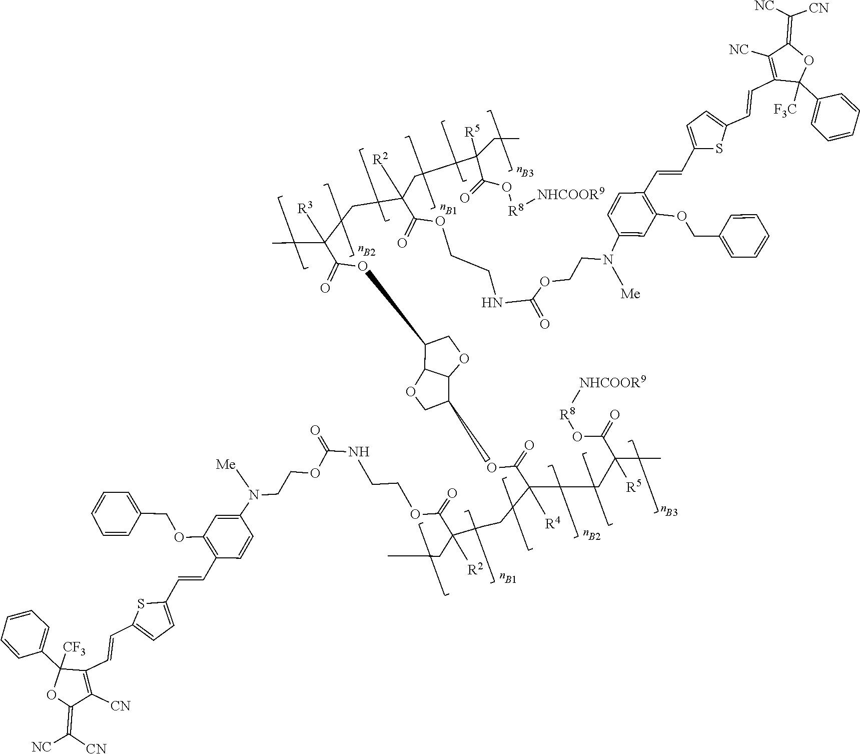

For the electro-optic polymer according to the second aspect, it is preferred that its glass transition temperature (hereinafter also referred to as Tg) be 230° C. or above, more preferably 250° C. or above. When the Tg is 230° C. or above, the electro-optic polymer can be deemed to be one having sufficiently high heat resistance.

The electro-optic polymer according to the second aspect can be manufactured by the following procedure.
(1) Preparation of materials that are to form the copolymer
(2) Production of the copolymer
(3) Introduction of the electro-optic structure
   (1) Preparation of Monomers that Are to Form the Copolymer

A monomer that gives a constituent unit represented by general formula (B1) and a monomer that gives a constituent unit represented by general formula (B2) are prepared. Optionally, a monomer that gives a constituent unit represented by general formula (B3) is prepared.

### (2) Production of the Copolymer

The copolymer having the (meth)acrylic chain is produced. The method for producing the copolymer is not particularly limited as long as it is a method in which (meth)acrylic materials are polymerized together. A production method known in the related art may be followed.

### (3) Introduction of the Electro-Optic Structure

Examples include the method of allowing the copolymer obtained in (2) and an electro-optic molecule that gives the electro-optic structure to react together in the presence of a solvent. The reaction may be performed under conditions such as under heat (e.g., at an internal temperature of 50° C. to 100° C.). The reaction, furthermore, may be performed in the presence of a catalyst.

Through this procedure, an electro-optic polymer including a backbone that is at least one (meth)acrylic chain and an electro-optic structure at a side chain on the backbone and having a crosslink can be obtained.

### Backbone Structure in a Third Aspect of the Electro-Optic Polymer

A third aspect of the electro-optic polymer according to the present disclosure includes a backbone that is a polyimide chain and an electro-optic structure at a side chain on the backbone.

A polyimide chain is a molecular structure with high heat resistance (a high Tg). By using a polyimide chain as the backbone of an electro-optic polymer, therefore, an electro-optic polymer with high heat resistance can be obtained.

The polyimide forming the polyimide chain is preferably a transparent polyimide. With a transparent polyimide, the polymer is suitable for use as an electro-optic polymer because there is no absorption of visible light.

As a guideline for transparency, it is preferred that the total transmittance be 85% or more, more preferably 88% or more, even more preferably 90% or more.

The polyimide chain may be an aromatic polyimide or may be an aliphatic polyimide. When the use of a transparent polyimide is considered, it is preferred that the polyimide chain be an aliphatic polyimide.

It is preferred that the polyimide chain have a constituent unit represented by general formula (C1) below.

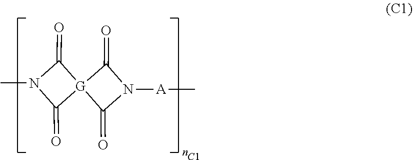

In general formula (C1), G is a tetravalent organic group, and A is a divalent organic group. G and/or A has a binding site for the electro-optic structure. n_{c1} is an integer of 1 or greater.

It is, furthermore, preferred that the polyimide chain have a constituent unit represented by general formula (C2) below.

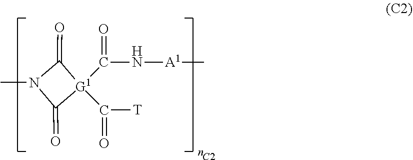

In general formula (C2), G¹ is a tetravalent organic group, and A¹ is a divalent organic group. T is a binding site of the electro-optic structure. n_{c2} is an integer of 1 or greater.

The polyimide chain may further include any one or more of the repeat units represented by general formula (C3), general formula (C4), and general formula (C5) unless characteristics of the resulting electro-optic polymer are impaired.

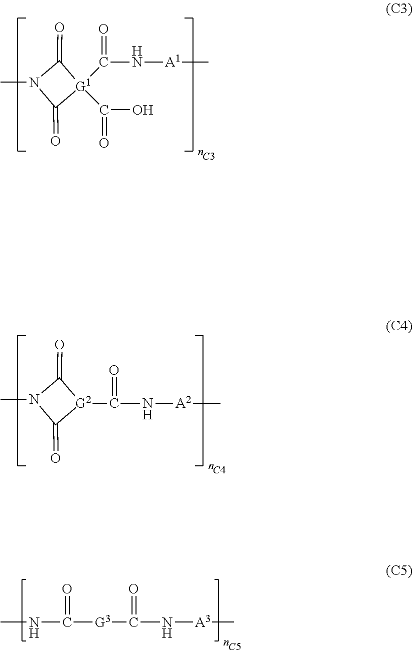

n_{c3} in general formula (C3), n_{c4} in general formula (C4), and n_{c5} in general formula (C5) are integers of 1 or greater.

In general formulae (C1), (C2), and (C3), G and G¹ represent tetravalent organic groups, preferably organic groups optionally substituted with a hydrocarbon group or fluorinated hydrocarbon group. For G and G¹, examples include the groups represented by formula (C6), formula (C7), formula (C8), formula (C9), formula (C10), formula (C11), general formula (C12), formula (C13), formula (C14), and formula (C15) as well as tetravalent open-chain hydrocarbon groups having six or fewer carbon atoms. * in formulae (C6) to (C15) represents a bond, and G⁴ in general formula (C12) represents a single bond, —O—, —CH₂—, —CH₂—CH₂—, —CH(CH₃)—, —C(CH₃)₂—, —C(CF₃)₂—, —Ar—, —SO₂—, —CO—, —O—Ar—O—, —Ar—O—Ar—, —Ar—CH₂—Ar—, —Ar—C(CH₃)₂—Ar—, or —Ar—SO₂—Ar—. Ar represents an arylene group having six to twenty carbon atoms and optionally substituted with a fluorine atom (more specifically, a group such as a phenylene group). For the reduction of the yellowness of the resulting polymer, it is preferred that G and G¹ represent groups represented by formulae (C6) to (C13).

In particular, the structure in which G⁴ in general formula (C12) is —C(CF₃)₂— is preferred.

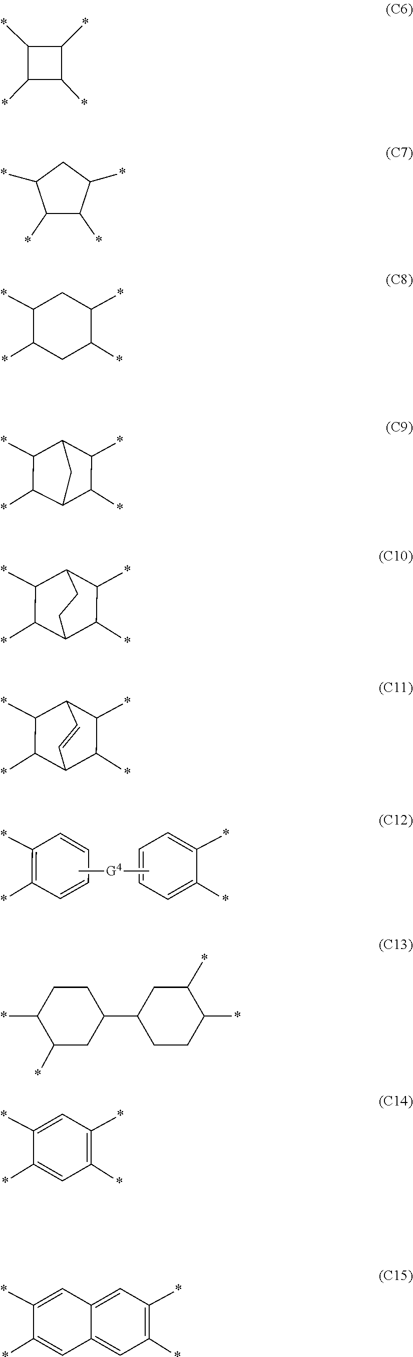

In general formula (C4), G² represents a trivalent organic group, preferably an organic group optionally substituted with a hydrocarbon group or fluorinated hydrocarbon group. Examples of trivalent organic groups represented by G² include groups represented by formula (C6), formula (C7), formula (C8), formula (C9), formula (C10), formula (C11), general formula (C12), formula (C13), formula (C14), and formula (C15) with any one of the bonds replaced with a hydrogen atom, as well as trivalent open-chain hydrocarbon groups having six or fewer carbon atoms.

In general formula (C5), G³ represents a divalent organic group, preferably an organic group optionally substituted with a hydrocarbon group or fluorinated hydrocarbon group. Examples of divalent organic groups represented by G³ include groups represented by formula (C6), formula (C7), formula (C8), formula (C9), formula (C10), formula (C11), general formula (C12), formula (C13), formula (C14), and formula (C15) with each of nonadjacent two of the bonds replaced with a hydrogen atom, as well as divalent open-chain hydrocarbon groups having six or fewer carbon atoms.

In general formulae (C1) to (C5), A, A¹, A², and A³ all represent divalent organic groups, preferably organic groups optionally substituted with a hydrocarbon group or fluorinated hydrocarbon group. For A, A¹, A², and A³, examples include the groups represented by formula (C16), formula (C17), formula (C18), formula (C19), general formula (C20), general formula (C21), general formula (C22), formula (C23), and formula (C24); forms of these groups substituted with a methyl, fluoro, chloro, or trifluoromethyl group; and open-chain hydrocarbon groups having six or fewer carbon atoms.

in formulae (C16) to (C24) represents a bond, and A⁴, A⁵, and A⁶ in general formulae (C20) to (C22) each independently represent a single bond, —O—, —CH₂—, —CH₂—CH₂—, —CH(CH₃)—, —C(CH₃)₂—, —C(CF₃)₂—, —SO₂—, or —CO—. In one example, A⁴ and A⁶ are —O—, and A⁵ represents —CH₂—, —C(CH₃)₂—, —C(CF₃)₂—, or —SO₂— at the same time. Preferably, A⁴ and A⁵ are at the meta or para positions with respect to each other on the ring, and so are A⁵ and A⁶.

Of these, the structure in which A⁴ in general formula (C20) is —CH₂— and the bonds on the aromatic rings are at the para positions is preferred.

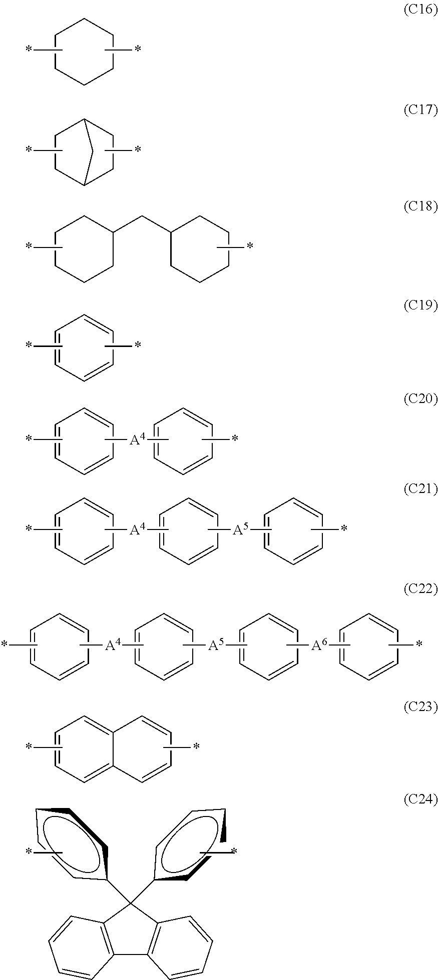

Repeat units represented by general formulae (C1), (C2), and (C3) are usually derived from a diamine and a tetracarboxylic acid compound. A repeat unit represented by general formula (C4) is usually derived from a diamine and a tricarboxylic acid compound. A repeat unit represented by general formula (C5) is usually derived from a diamine and a dicarboxylic acid compound. The carboxylic acid compounds (tetracarboxylic acid compound, tricarboxylic acid compound, and dicarboxylic acid compound) may be analogues of carboxylic acid compounds (more specifically, carboxylic anhydrides, alkanoyl halides, etc.).

For further improvement of the transparency of the electro-optic polymer, it is preferred that the tetracarboxylic acid compound be an alicyclic tetracarboxylic dianhydride or an aromatic tetracarboxylic dianhydride of non-fused polycyclic type, more preferably 3,3′,4,4′-biphenyltetracarboxylic dianhydride, 2,2′,3,3′-biphenyltetracarboxylic dianhydride, 2,2-bis(3,4-dicarboxyphenyl)propane dianhydride, or 4,4′-(hexafluoroisopropylidene)diphthalic dianhydride (6FDA). One of these preferred tetracarboxylic acid compounds may be used alone, or two or more may be used in combination.

Tricarboxylic acid compounds include, for example, aromatic tricarboxylic acids, aliphatic tricarboxylic acids, and acid chloride compounds and acid anhydrides analogous to them. One of such tricarboxylic acid compounds may be used alone, or two or more may be used in combination. Examples of tricarboxylic acid compounds include the anhydride of 1,2,4-benzenetricarboxylic acid; 2,3,6-naphthalenetricarboxylic acid-2,3-anhydride; and compounds in which phthalic anhydride and benzoic acid are coupled together by a single bond, —CH₂—, —C(CH₃)₂—, —C(CF₃)₂—, —SO₂—, or a phenylene group.

Dicarboxylic acid compounds include, for example, aromatic dicarboxylic acids, aliphatic dicarboxylic acids, and acid anhydrides analogous to them. One of such dicarboxylic acid compounds may be used alone, or two or more may be used in combination. Examples of dicarboxylic acid compounds include terephthalic acid; isophthalic acid; naphthalenedicarboxylic acid; 4,4′-biphenyldicarboxylic acid; 3,3′-biphenyldicarboxylic acid; and dicarboxylic acid compounds of open-chain hydrocarbons having eight or fewer carbon atoms and compounds in which two benzoic acids are coupled together by —CH₂—, —C(CH₃)₂—, —C(CF₃)₂—, —SO₂—, or a phenylene group.

Diamines include, for example, aliphatic diamines, aromatic diamines, and their mixtures. As used herein, “aromatic diamine” represents a diamine in which the amino groups are bound directly to at least one aromatic ring, and part of its structure may include an aliphatic group or other substituent. The aromatic ring may be a monocycle or fused-ring system. Examples of aromatic rings include, but are not limited to, a benzene ring, a naphthalene ring, an anthracene ring, and a fluorene ring. Of aromatic rings, a benzene ring is particularly preferred. As used herein, furthermore, “aliphatic diamine” refers to a diamine in which the amino groups are bound directly to an aliphatic group, and part of its structure may include an aromatic ring or other substituent.

Of such diamines, it is particularly preferred to use one or more selected from the group consisting of aromatic diamines having a biphenyl structure, when high transparency and low coloring potential are sought. It is more preferred to use one or more selected from the group consisting of 2,2′-dimethylbenzidine, 2,2′-bis(trifluoromethyl)benzidine (TFMB) derivatives, and 4,4′-bis(4-aminophenoxy)biphenyl.

The diamine is preferably a diamine having a biphenyl structure and a fluorine substituent. Examples of diamines having a biphenyl structure and a fluorine substituent include 2,2′-bis(trifluoromethyl)benzidine (TFMB) derivatives.

It is, furthermore, preferred that the diamine be a diphenylmethanediamine derivative, preferably a derivative of diphenylmethanediamine having a substituent that gives a binding site for the electro-optic structure. An example of a derivative is 5,5′-methylenebis(2-aminobenzoic acid) (MBAA), which is a dimethylmethanediamine having a COOH group on each of its two aromatic rings.

The forms that the polyimide chain can take include the following ones, which are based on the difference in the position in general formula (C1) or (C2) that the chain has its binding site for the electro-optic structure.

(Form A) A form in which organic group G in a structure presented in general formula (C1) or (C2) has a binding site for the electro-optic structure

(Form B) A form in which organic group A in a structure presented in general formula (C1) or (C2) has a binding site for the electro-optic structure

(Form C) A form in which the binding site T in the structure presented in general formula (C2) is a binding site for the electro-optic structure

It should be noted that the structure presented in general formula (C2) is a structure in which the end of a COOH group in a polyamic acid that is a precursor to the imide structure is a binding site for the electro-optic structure. In the present description, backbones having such a moiety are also included in polyimide chains.

In the case of a backbone having the structure presented in general formula (C2), an imide ring is formed through imidization where the end of a COOH group of the polyamic acid is not bound with the electro-optic structure. The backbone as a whole, therefore, can be deemed to be a polyimide chain.

In the following, the binding site of the polyimide chain for the electro-optic structure will be described.

### Polyimide Chain in (Form A)

An example is a structure in which at least one portion, of G and G¹ as tetravalent organic groups presented in formulae (C6) to (C15) above, that is not a bond is the binding site for the electro-optic structure.

Possible structures of the binding site are the same as those for X¹, described in relation to general formula (A1) in the first aspect of the electro-optic polymer (hereinafter X⁴).

That is, the binding site is preferably the residue of a substituent that produces a binding site formed by at least one selected from the group consisting of a (thio)ester bond, a (thio)urethane bond, a (thio)urea bond, and a (thio)amide bond.

The number of binding sites that G and G¹ as tetravalent organic groups have may be one or may be two or more.

X⁴ is, for example, a residue left after the end of —COO—R—NCO, —COO—R—NHCOOR¹, —R—COOR¹, —COOR¹, —R—COOH, or COOH binds with a binding site of the electro-optic structure.

R is a substituted or unsubstituted alkylene group. Examples of substituents include a halogen, an alkyl group, and an aryl group. The number of carbon atoms in the alkylene group is not limited, but preferably is two or more and eight or fewer, more preferably two or three, even more preferably two.

R¹ is a substituted or unsubstituted alkyl group. The number of carbon atoms in the alkyl group is preferably from one to ten. The alkyl group may be a linear chain or may be a branched chain, and examples of substituents include a halogen and an aryl group.

The number of carbon atoms in the R¹ alkyl group is preferably one or more and twelve or fewer, more preferably one or more and four or fewer.

Specific examples include a methyl group, an ethyl group, a propyl group, an isopropyl group, an n-butyl group, an i-butyl group, a t-butyl group, an n-pentyl group, an n-hexyl group, an n-heptyl group, an n-octyl group, and a 2-ethylhexyl group. Preferably, R¹ is a methyl group.

It is, therefore, preferred that R be an ethylene group and R¹ be a methyl group, and X⁴ is preferably a residue left after the end of —COO—C₂H₄—NCO, —COO—C₂H₄—NHCOOCH₃, —C₂H₄—COOCH₃, or —C₂H₄—COOH binds with a binding site of the electro-optic structure. Preferably, furthermore, X⁴ is a residue left after a —COOR¹ end or —COOH end binds with a binding site of the electro-optic structure.

When the structure of X⁴ before binding with the electro-optic structure is —COO—R—NCO or —COO—R—NHCOOR¹, the NCO end or NHCOOR¹ end produces a (thio)urethane bond by reacting with an OH group at a binding site of the electro-optic structure. In that case, X⁴ is a residue left after a (thio)urethane bond is formed through reaction with an OH group at a binding site of the electro-optic structure.

When X⁴ is the residue of —R—COOR¹, —COOR¹, —R—COOH, or —COOH, the COOR¹ end or COOH end is the binding site for the electro-optic structure, and X⁴ may be a residue left after a (thio)ester bond is formed through reaction with an OH group at a binding site of the electro-optic structure. When X⁴ is the residue of —R—COOR¹, —COOR¹, —R—COOH, or —COOH, furthermore, X⁴ may be a residue left after a (thio)amide bond is formed through reaction with an NH₂ group at a binding site of the electro-optic structure.

Examples of polyimide chains in (form A) include the following structures.

Presented below is the structure of a precursor tetracarboxylic anhydride in which the tetravalent organic group G is formula (C12) and G⁴ is —C(CF₃)₂—. In the structure presented below, the compound has a substituent X⁴′ on each of the benzene rings that form the tetravalent organic group G.

The substituents X⁴′ are the structures of X⁴ before binding with the electro-optic structure.

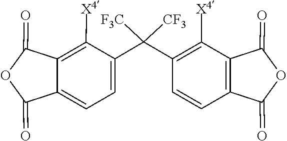

Examples of structures obtained by binding an electro-optic molecule that gives the electro-optic structure to this structure and allowing the product to react with a diamine to give a polyimide include structures such as the following.

An example for when the end of the binding site before binding with the electro-optic structure is a COOR¹ group or COOH group and when the electro-optic molecule from which the electro-optic structure has been derived is the molecule of formula (E3) is presented below. The binding site is ester bonds.

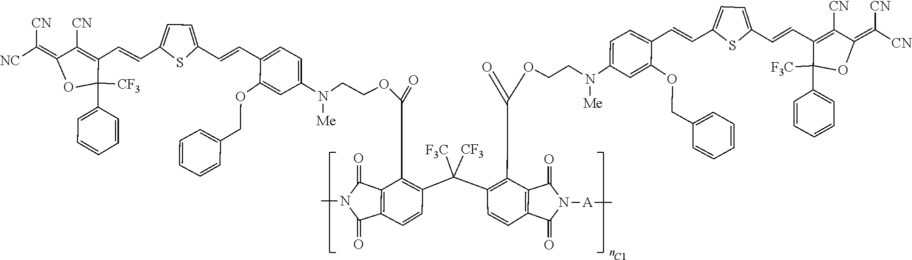

### Polyimide Chain in (Form B)

An example is a structure in which at least one portion, of A and A¹ presented in formulae (C16) to (C24) above, that is not a bond is the binding site for the electro-optic structure.

Possible structures of the binding site are the same as those for X⁴, described in relation to (form A).

Examples of polyimide chains in (form B) include the following structures.

Presented below is the structure of a precursor diamine in which the divalent organic group A is general formula (C20), A⁴ is —CH₂, and the bonds on the aromatic rings are at the para positions. In the structure presented below, the compound has a substituent X⁴′ on each of the benzene rings that form the divalent organic group A.

The substituents X⁴′ are the structures of X⁴ before binding with the electro-optic structure.

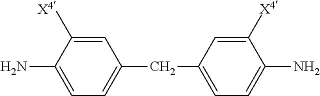

Examples of structures obtained by binding an electro-optic molecule that gives the electro-optic structure to this structure and allowing the product to react with a tetracarboxylic acid to give a polyimide include structures such as the following.

An example for when the end of the binding site before binding with the electro-optic structure is a COOR¹ group or COOH group and when the electro-optic molecule from which the electro-optic structure has been derived is the molecule of formula (E3) is presented below. The binding site is ester bonds.

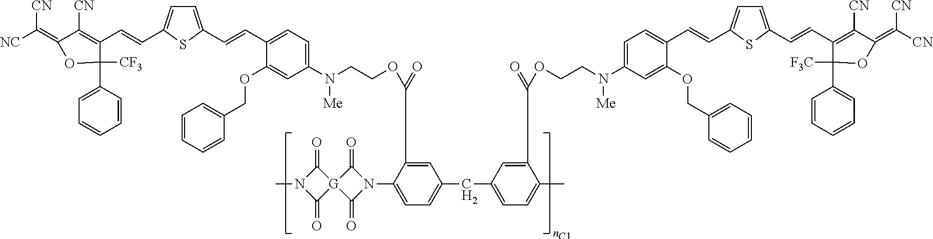

### Polyimide Chain in (Form C)

An example is a structure in which an electro-optic molecule that gives the electro-optic structure is bound to the binding site T in general formula (C2) above.

An example of a polyimide chain in (form C) is the following structure.

An example for when the electro-optic molecule from which the electro-optic

structure has been derived is the molecule of formula (E3) is presented.

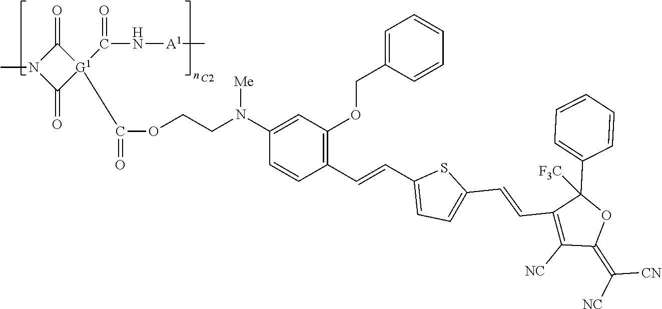

For one polyimide chain that constitutes the electro-optic polymer, the binding site for the electro-optic structure may be in any one of (form A), (form B), or (form C), may be in any two, or may be in the three.

The ratio between structures in (form A), (form B), and (form C) is not particularly limited either.

For the electro-optic polymer according to the third aspect, it is preferred that its glass transition temperature (hereinafter also referred to as Tg) be 230° C. or above, more preferably 250° C. or above. When the Tg is 230° C. or above, the electro-optic polymer can be deemed to be one having sufficiently high heat resistance.

When in (form A) or (form B), the electro-optic polymer according to the third aspect can be manufactured by the following procedure.
(1) Preparation of materials for a polyimide precursor
(2) Introduction of the electro-optic structure
(3) Production of the copolymer
(1) Preparation of Materials for a Polyimide Precursor

A diamine and a tetracarboxylic acid compound, which are materials for a polyimide precursor, are prepared. Optionally, a dicarboxylic acid compound and/or a tricarboxylic acid compound may also be used.

In the case of (form A), a substituent that gives the binding site for the electro-optic structure is introduced to the tetracarboxylic acid compound beforehand.

In the case of (form B), a substituent that gives the binding site for the electro-optic structure is introduced to the diamine beforehand.

### (2) Introduction of the Electro-Optic Structure

Examples include the method of allowing the diamine or tetracarboxylic acid compound prepared in (1) and an electro-optic molecule that gives the electro-optic structure to react together in the presence of a solvent. The reaction may be performed under conditions such as under heat (e.g., at an internal temperature of 50° C. to 100° C.). The reaction, furthermore, may be performed in the presence of a catalyst.

In the case of (form C), the introduction of the electro-optic structure is not performed at this stage.

### (3) Production of the Copolymer

A precursor to the polyimide chain is formed by polymerizing the materials for a polyimide precursor in a solvent. An imidization step follows, causing imide rings to be formed and giving the polyimide chain.

When in (form C), the electro-optic polymer according to the third aspect can be manufactured by the following procedure.
(1) Preparation of materials for a polyimide precursor
(2) Formation of a precursor to the polyimide chain
(3) Introduction of the electro-optic structure
(4) Imidization step
(1) Preparation of Materials for a Polyimide Precursor

A diamine and a tetracarboxylic acid compound, which are materials for a polyimide precursor, are prepared. Optionally, a dicarboxylic acid compound and/or a tricarboxylic acid compound may also be used.

### (2) Formation of a Precursor to the Polyimide Chain

A polyamic acid, which is a precursor to the polyimide chain, is formed by polymerizing the materials for a polyimide precursor in a solvent.

### (3) Introduction of the Electro-Optic Structure

The electro-optic structure is introduced by allowing a subset of the COOH groups in the polyamic acid to react with the electro-optic molecule, using the COOH group or groups as the binding site for the electro-optic structure.

### (4) Imidization Step

An imidization step is performed for the COOH group or groups that are not the binding site for the electro-optic structure. Of the COOH groups in the polyamic acid, the group or groups that are the binding site for the electro-optic structure are not closed.

The formation of a precursor to the copolymer and the imidization step may follow manufacturing methods known in the related art.

Through this procedure, an electro-optic polymer including a backbone that is a polyimide chain and an electro-optic structure at a side chain on the backbone can be obtained.

Presented below are examples of the synthesis of electro-optic polymers in (form A), (form B), and (form C) through the above process.
Example for (Form A)
Steps (1) and (2)

The tetracarboxylic acid compound presented below, having COOH groups as substituents X⁴′, is prepared.

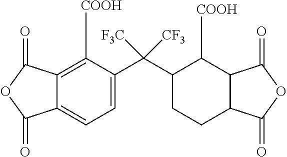 [SMILES: O=C1OC(=O)c2c1ccc(C(C1CCC3C(=O)OC(=O)C3C1C(=O)O)(C(F)(F)F)C(F)(F)F)c2C(=O)O]

The electro-optic structure is introduced by allowing the electro-optic molecule to react with the COOH groups in this tetracarboxylic acid compound. An example for when the electro-optic molecule that gives the electro-optic structure is the molecule of formula (E3) is presented below. The binding site is ester bonds.

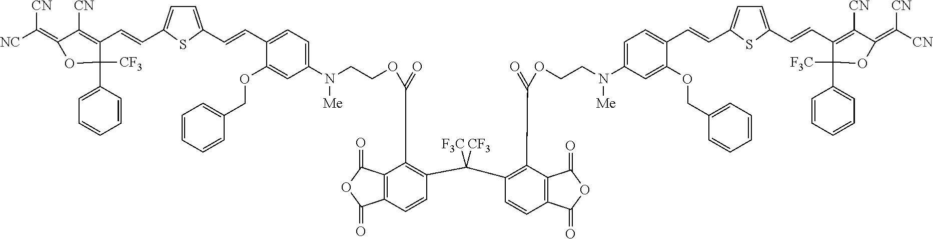 [SMILES: CN(CCOC(=O)c1c(C(c2ccc3c(c2C(=O)OCCN(C)c2ccc(/C=C/c4ccc(/C=C/C5=C(C#N)C(=C(C#N)C#N)OC5(c5ccccc5)C(F)(F)F)s4)c(OCc4ccccc4)c2)C(=O)OC3=O)(C(F)(F)F)C(F)(F)F)ccc2c1C(=O)OC2=O)c1ccc(/C=C/c2ccc(/C=C/C3=C(C#N)C(=C(C#N)C#N)OC3(c3ccccc3)C(F)(F)F)s2)c(OCc2ccccc2)c1]

### Step (3)

A precursor to the polyimide chain is formed by allowing the tetracarboxylic acid compound prepared in step (2) and a diamine to react together and polymerizing them in a solvent. An imidization step follows, causing imide rings to be formed and giving a polyimide chain having the following structure.

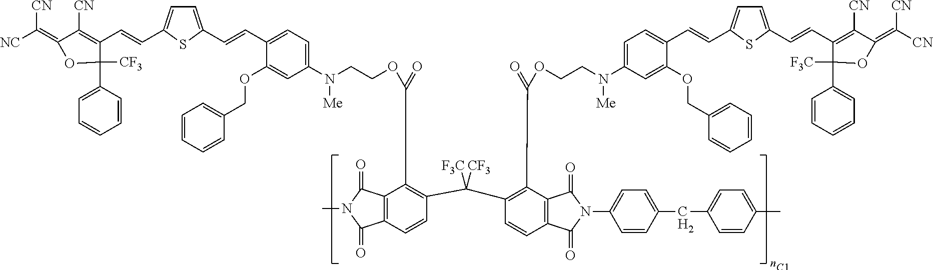

### Example for (Form B)

### Steps (1) and (2)

The diamine presented below, having COOH groups as substituents X⁴′, is prepared.

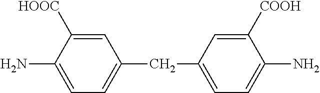 [SMILES: Nc1ccc(Cc2ccc(N)c(C(=O)O)c2)cc1C(=O)O]

The electro-optic structure is introduced by allowing the electro-optic molecule to react with the COOH groups in this diamine. An example for when the electro-optic molecule that gives the electro-optic structure is the molecule of formula (E3) is presented below. The binding site is ester bonds.

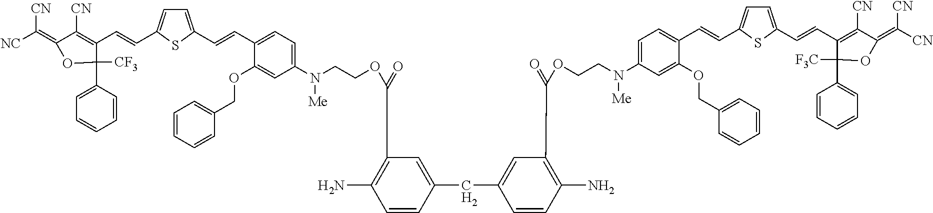 [SMILES: CN(CCOC(=O)c1cc(Cc2ccc(N)c(C(=O)OCCN(C)c3ccc(/C=C/c4ccc(/C=C/C5=C(C#N)C(=C(C#N)C#N)OC5(c5ccccc5)C(F)(F)F)s4)c(OCc4ccccc4)c3)c2)ccc1N)c1ccc(/C=C/c2ccc(/C=C/C3=C(C#N)C(=C(C#N)C#N)OC3(c3ccccc3)C(F)(F)F)s2)c(OCc2ccccc2)c1]

### Step (3)

A precursor to the polyimide chain is formed by allowing the diamine prepared in step (2) and a tetracarboxylic acid compound to react together and polymerizing them in a solvent. An imidization step follows, causing imide rings to be formed and giving a polyimide chain having the following structure.

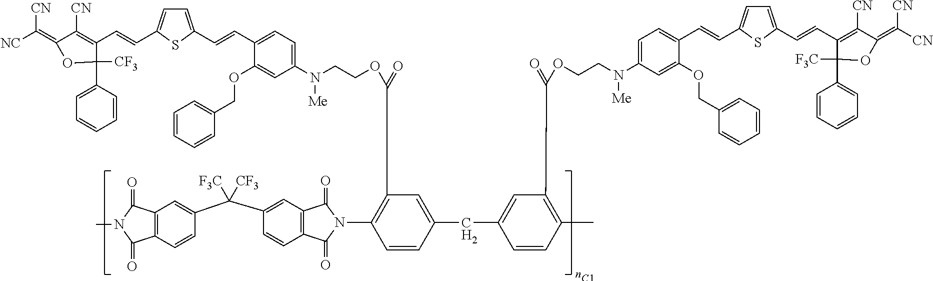

### Example for (Form C)

### Steps (1) and (2)

A diamine and a tetracarboxylic acid compound are allowed to react together to give the polyamic acid presented below, which is a precursor to the polyimide chain.

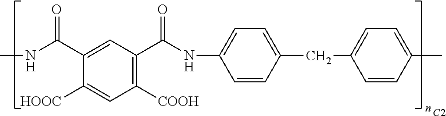

### Step (3)

The electro-optic structure is introduced by allowing the electro-optic molecule to react with a COOH group in the polyamic acid prepared in step (2). An example for when the electro-optic molecule that gives the electro-optic structure is the molecule of formula (E3) is presented below. The binding site is an ester bond.

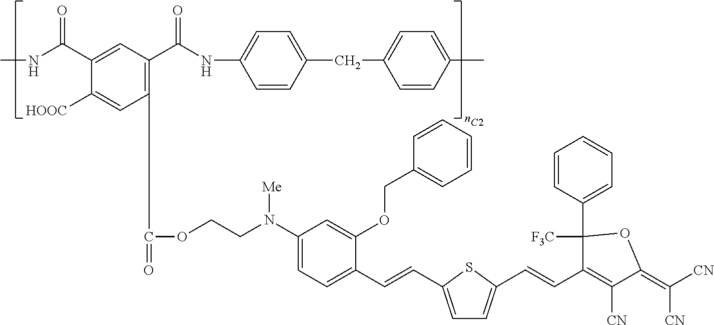

### Step (4)

An imidization step is performed for the COOH group that is not the binding site for the electro-optic structure. Of the COOH groups in the polyamic acid, the group that is the binding site for the electro-optic structure is not closed.

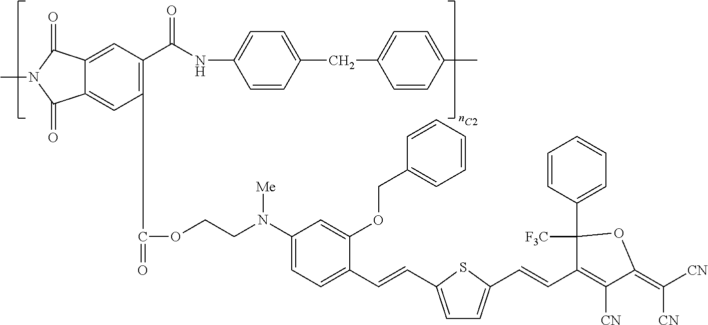

### Backbone Structure in a Fourth Aspect of the Electro-Optic Polymer

A fourth aspect of the electro-optic polymer according to the present disclosure includes a backbone having at least one triazine ring and an electro-optic structure at a side chain on the backbone.

A backbone having a triazine ring is a molecular structure with high heat resistance (a high Tg). By using a backbone having a triazine ring as the backbone of an electro-optic polymer, therefore, an electro-optic polymer with high heat resistance can be obtained.

It is preferred that the backbone having at least one triazine ring is a structure in which a constituent unit represented by general formula (D1) below has formed the triazine ring through polymerization and that a subset of the OCN ends be at least one binding site for the electro-optic structure.

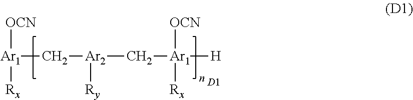

In general formula (D1), Ar₂ represents a phenylene, naphthylene, or biphenylene group. When Ar₂ is a phenylene group, Ar₁ represents a naphthylene or biphenylene group, and when Ar₂ is a naphthylene or biphenylene group, Ar₁ represents a phenylene, naphthylene, or biphenylene group.

Rₓ is all substituents in Ar₁, each of which may independently be an identical group or different group. Rₓ represents a hydrogen, alkyl group, or aryl group. R_{y} is all substituents in Ar₂, each of which may independently be an identical group or different group. R_{y} represents a hydrogen atom, alkyl group, or aryl group. n_{D1} is an integer of 1 or greater.

The OCN ends in the structure indicated by general formula (D1) are binding sites for the electro-optic structure and produce cyanate ester bonds by reacting with OH groups at binding sites of the electro-optic structure.

Preferably, the backbone having at least one triazine ring further has a constituent unit having an epoxy group.

The constituent unit having an epoxy group can be part of the epoxy resins listed below by way of example. The examples include bisphenol A epoxy resins, bisphenol F epoxy resins, biphenyl epoxy resins, phenol novolac epoxy resins, cresol novolac epoxy resins, xylene novolac epoxy resins, triglycidyl isocyanurate, alicyclic epoxy resins, dicyclopentadiene novolac epoxy resins, biphenyl novolac epoxy resins, phenol aralkyl novolac epoxy resins, and naphthol aralkyl novolac epoxy resins.

When a constituent unit having an epoxy group is introduced into the backbone having at least one triazine ring, an epoxy resin curing agent can be used. The epoxy resin curing agent can be a generally known one, and examples include imidazole derivatives, such as 2-methylimidazole, 2-ethyl-4-methylimidazole, 2-phenylimidazole, 1-cyanoethyl-2-phenylimidazole, 1-cyanoethyl-2-ethyl-4-methylimidazole, 2-phenyl-4,5-dihydroxymethylimidazole, and 2-phenyl-4-methyl-5-hydroxymethylimidazole, and amine compounds, such as dicyandiamide, benzyldimethylamine, and 4-methyl-N,N-dimethylbenzylamine, phosphorus compounds of phosphonium type or phosphines type.

Specific examples of electro-optic polymers for when the electro-optic polymer has a constituent unit represented by general formula (D1) include structures such as the following.

The * marks in the structure below are bonds. A bond may be a site to which the electro-optic structure has been bound as in the lower right structure or may be a site to which no electro-optic structure has been bound.

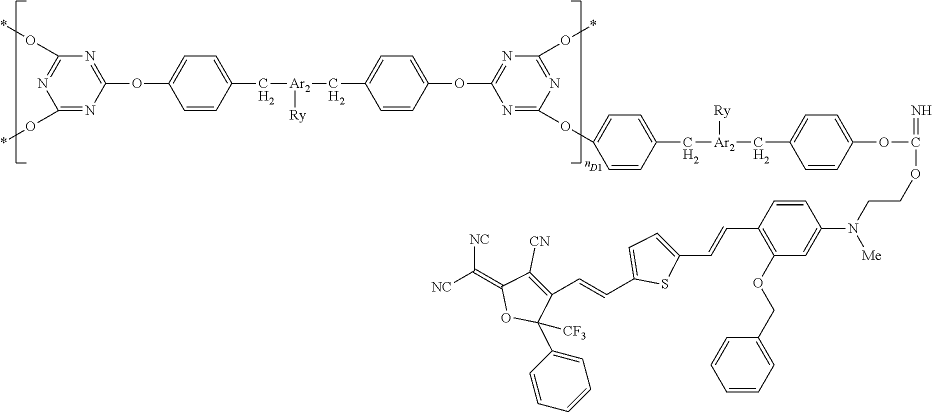

For the electro-optic polymer according to the fourth aspect, it is preferred that its glass transition temperature (hereinafter also referred to as Tg) be 230° C. or above, more preferably 250° C. or above. When the Tg is 230° C. or above, the electro-optic polymer can be deemed to be one having sufficiently high heat resistance.

The electro-optic polymer according to the fourth aspect can be manufactured by the following procedure.
(1) Preparation of a cyanate monomer
(2) Introduction of the electro-optic structure
(3) Production of a cyanate ester resin having at least one triazine ring
(1) Preparation of a Cyanate Monomer

A cyanate monomer having OCN groups at its ends is prepared. For example, monomers such as ones manufactured by Mitsubishi Gas Chemical Company, Inc. (CYTESTER®) can be used.

### (2) Introduction of the Electro-Optic Structure

The cyanate monomer and an electro-optic molecule that gives the electro-optic structure are allowed to react together in the presence of a solvent. The reaction may be performed under conditions such as under heat (e.g., at an internal temperature of 50° C. to 100° C.). The reaction, furthermore, may be performed in the presence of a catalyst. By adjusting the number of moles of OCN groups in the cyanate monomer and the number of moles of binding sites of the electro-optic molecule, the electro-optic structure can be introduced to a subset of the OCN groups in the cyanate monomer.

### (3) Production of a Cyanate Ester Resin Having at Least One Triazine Ring

A curable resin composition is prepared by mixing the cyanate monomer prepared in (2), having an introduced electro-optic structure on part of it, and a curing catalyst together. To the curable resin composition, other resins, such as an epoxy resin, may optionally be added.

Examples of curing catalysts include metal salts, such as zinc octylate, zinc naphthenate, cobalt naphthenate, copper naphthenate, and iron acetylacetone, and compounds having an active hydroxyl group, such as phenol, alcohols, and amines.

By curing the curable resin composition with heat, the electro-optic polymer can be obtained. The curing temperature is preferably in a range of 150° C. to 300° C. because when it is too low, the curing does not proceed, and when it is too high, degradation of the cured product occurs.

In the present description, the following matters are disclosed.
(1) of the present disclosure is an electro-optic polymer including a backbone that is a polynorbornene chain and an electro-optic structure at a side chain on the backbone.
(2) of the present disclosure is the electro-optic polymer according to (1) of the present disclosure, wherein the backbone that is a polynorbornene chain and the electro-optic structure are bound together by at least one binding site formed by at least one selected from the group consisting of a (thio)ester bond, a (thio)urethane bond, a (thio)urea bond, and a (thio)amide bond.
(3) of the present disclosure is the electro-optic polymer according to (1) or (2) of the present disclosure, wherein the polymer has a constituent unit represented by general formula (A2) below.

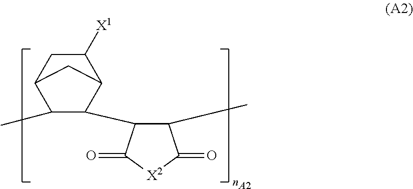

In general formula (A2), at least one of X¹ or X² is a binding site between the polynorbornene chain and the electro-optic structure. When X¹ is a binding site, X² may be —O— or —NH— rather than a binding site. When X² is a binding site, X¹ may be a hydrogen atom or substituted or unsubstituted alkyl group. n_{A2} is an integer of 1 or greater.
(4) of the present disclosure is the electro-optic polymer according to any of (1) to (3) of the present disclosure, wherein the polymer has a constituent unit represented by general formula (A3) below.

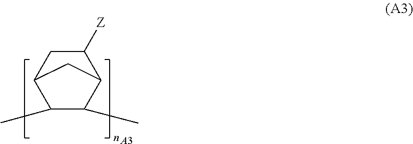

In general formula (A3), Z is a hydrogen atom or substituted or unsubstituted alkyl group. n_{A3} is an integer of 1 or greater.
(5) of the present disclosure is an electro-optic polymer including a backbone that is at least one (meth)acrylic chain having a constituent unit represented by general formula (B1) below and an electro-optic structure at a side chain on the backbone, wherein:
the polymer further has a constituent unit that is represented by general formula (B2) below and that forms a crosslink through copolymerization with a monomer that gives the constituent unit represented by general formula (B1).

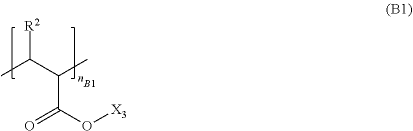

In general formula (B1), X³ is a binding site between the (meth)acrylic chain and the electro-optic structure. R² is a hydrogen atom or methyl group. n_{B1} is an integer of 1 or greater.

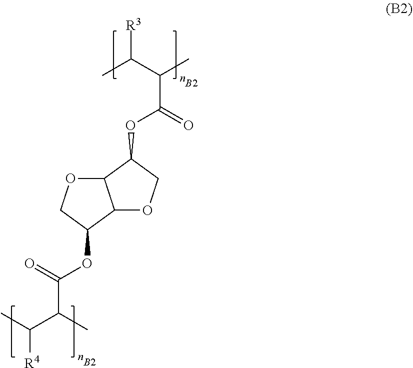

In general formula (B2), R³ and R⁴ are hydrogen atoms or methyl groups. n_{B2} is an integer of 1 or greater.
(6) of the present disclosure is an electro-optic polymer including a backbone that is a polyimide chain and an electro-optic structure at a side chain on the backbone.
(7) of the present disclosure is the electro-optic polymer according to (6) of the present disclosure, wherein the polyimide chain has a constituent unit represented by general formula (C1) below.

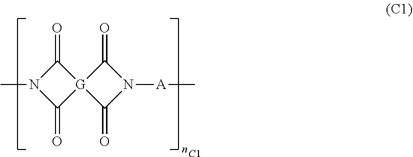

In general formula (C1), G is a tetravalent organic group, and A is a divalent organic group. G and/or A has a binding site for the electro-optic structure. n_{c1} is an integer of 1 or greater.
(8) of the present disclosure is an electro-optic polymer including a backbone having at least one triazine ring and an electro-optic structure at a side chain on the backbone.
(9) of the present disclosure is the electro-optic polymer according to (8) of the present disclosure, wherein the backbone having at least one triazine ring is a structure in which a constituent unit represented by general formula (D1) below has formed the triazine ring through polymerization, and a subset of the OCN ends is at least one binding site for the electro-optic structure.

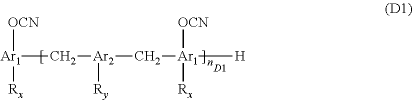

In general formula (D1), Ar₂ represents a phenylene, naphthylene, or biphenylene group. When Ar₂ is a phenylene group, Ar₁ represents a naphthylene or biphenylene group, and when Ar₂ is a naphthylene or biphenylene group, Ar₁ represents a phenylene, naphthylene, or biphenylene group.

Rₓ is all substituents in Ar₁, each of which may independently be an identical group or different group. Rₓ represents a hydrogen, alkyl group, or aryl group. R_{y} is all substituents in Ar₂, each of which may independently be an identical group or different group. R_{y} represents a hydrogen atom, alkyl group, or aryl group. n_{D1} is an integer of 1 or greater.
(10) of the present disclosure is the electro-optic polymer according to any of (1) to (9) of the present disclosure, wherein the electro-optic structure is a structure represented by a donor structure-a bridge structure-an acceptor structure.
(11) of the present disclosure is the electro-optic polymer according to any of (1) to (10) of the present disclosure, wherein the electro-optic structure is a structure represented by formula (E-a) below.

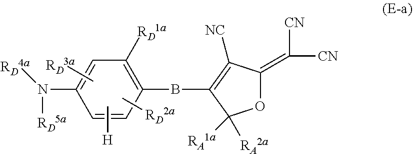

In general formula (E-a), R_{D}^{1a}, R_{D}^{2a}, and R_{D}^{3a} each independently indicate a hydrogen atom, an alkyl group, an alkoxy group, an aryloxy group, an aralkyloxy group, a silyloxy group, an alkenyloxy group, an alkynyloxy group, a hydroxy group, -Rd¹-OH (where Rd¹ is a hydrocarbon group), —ORd²-OH (where Rd² is a hydrocarbon group), —OC(═O)Rd³ (where Rd³ is a hydrocarbon group), an amino group, -Rd⁴-NH₂ (where Rd⁴ is a hydrocarbon group), a thiol group, -Rd⁵-SH (where Rd⁵ is a hydrocarbon group), —NCO, or -Rd⁶-NCO (where Rd⁶ is a hydrocarbon group).

At least one of R_{D}^{4a} or R_{D}^{5a} is a structure including a binding site for the backbone and indicates a residue left after an acyloxyalkyl group, a silyloxyalkyl group, -Rd¹-OH (where Rd¹ is a hydrocarbon group), -Rd⁴-NH₂ (where Rd⁴ is a hydrocarbon group), -Rd⁵-SH (where Rd⁵ is a hydrocarbon group), or -Rd⁶-NCO (where Rd⁶ is a hydrocarbon group) binds with a binding site of the backbone.

Of R_{D}^{4a} and R_{D}^{5a}, any structure that is not a binding site for the backbone indicates an alkyl group, a haloalkyl group, an acyloxyalkyl group, a silyloxyalkyl group, -Rd¹-OH (where Rd¹ is a hydrocarbon group), -Rd⁴-NH₂ (where Rd⁴ is a hydrocarbon group), an aryl group, -Rd⁵-SH (where Rd⁵ is a hydrocarbon group), or -Rd⁶-NCO (where Rd⁶ is a hydrocarbon group).

B indicates a linking group, and R_{A}^{1a} and R_{A}^{2a} each independently indicate a hydrogen atom, an alkyl group, an alkenyl group, a cycloalkyl group, a cycloalkenyl group, an alkoxy group, a halogenated hydrocarbon group, an aryl group, a hydroxy group, —Ra¹—OH (where Ra¹ is a hydrocarbon group), —ORa²—OH (where Ra² is a hydrocarbon group), an amino group, —Ra⁴—NH₂ (where Ra⁴ is a hydrocarbon group), a thiol group, —Ra⁵—SH (where Ra⁵ is a hydrocarbon group), —NCO, or —Ra⁶—NCO (where Ra⁶ is a hydrocarbon group).

### EXAMPLES

The present disclosure will now be specifically described with examples. The present disclosure, however, is not limited to the Examples unless it departs from the gist of the present disclosure.

### Measurement of Tg

The Tg of the electro-optic polymers synthesized in the Examples was measured using a differential scanning calorimeter (Rigaku Thermo plus DSC 8230, manufactured by Rigaku Corporation) under the following conditions: the measurement sample, 10 mg; the reference sample, an Al blank cell; atmosphere, nitrogen; the temperature elevation rate, 10° C./min.

### Examples of the First Aspect of the Electro-Optic Polymer

### (Examples 1-1 to 1-8)

Electro-optic polymers each having a constituent unit represented by general formula (A1) and a constituent unit represented by general formula (A3) as their polynorbornene chain were synthesized. The compositions of the electro-optic polymers are presented in Table 1.

### (Examples 1-9 and 1-10)

Electro-optic polymers each having a constituent unit represented by general formula (A2) and a constituent unit represented by general formula (A3) as their polynorbornene chain were synthesized. The compositions of the electro-optic polymers are presented in Table 1.

The substituents in Table 1 represent the following substituents.
SC-1: The residue of —COO—C₂H₄—NHCOOCH₃
SC-2: The residue of —C₂H₄—COOH
SC-3: A 2-ethylhexyl group
SC-4: An n-butyl group
SC-5: A hydrogen atom

When the substituent X¹ having a binding site is SC-1, the electro-optic structure is a structure made using the molecule of formula (E3) as the electro-optic molecule. When the substituent X¹ having a binding site is SC-2, the electro-optic structure is a structure made using the molecule of formula (E4) as the electro-optic molecule.

The ratios between constituent units in Table 1 are molar ratios, and
(A1):(A3)=33:67 is intended for a molar ratio (A1):(A3)=1:2;
(A1):(A3)=50:50 is intended for a molar ratio (A1):(A3)=1:1;
(A1):(A3)=67:33 is intended for a molar ratio (A1):(A3)=2:1; and
(A2):(A3)=50:50 is intended for a molar ratio (A2):(A3)=1:1.

TABLE 1

| | Blend ratio (molar ratio) | | | | | | | |
|---|---|---|---|---|---|---|---|---|
| | between constituent units | | | Substituents | | | Electro-optic | Tg |
| | (A1) | (A2) | (A3) | X¹ | X² | Z | structure | [° C.] |
| Example 1-1 | 33 | 0 | 67 | SC-1 | — | SC-4 | E3 | 202 |
| Example 1-2 | 50 | 0 | 50 | SC-1 | — | SC-4 | E3 | 231 |
| Example 1-3 | 67 | 0 | 33 | SC-1 | — | SC-4 | E3 | 255 |
| Example 1-4 | 33 | 0 | 67 | SC-2 | — | SC-4 | E4 | 211 |
| Example 1-5 | 50 | 0 | 50 | SC-2 | — | SC-4 | E4 | 239 |
| Example 1-6 | 67 | 0 | 33 | SC-2 | — | SC-4 | E4 | 261 |
| Example 1-7 | 50 | 0 | 50 | SC-1 | — | SC-5 | E3 | 276 |
| Example 1-8 | 67 | 0 | 33 | SC-1 | — | SC-5 | E3 | 265 |
| Example 1-9 | 0 | 50 | 50 | SC-2 | —O— | SC-3 | E4 | 245 |
| Example 1-10 | 0 | 50 | 50 | SC-2 | —O— | SC-4 | E4 | 255 |

The electro-optic polymers synthesized in the Examples all had a high Tg. For Examples 1-1 to 1-6, the lower the percentage of constituent unit (A3), the higher the Tg is. Since a high percentage of constituent unit (A3) makes the electro-optic polymer a material that is easy to handle, the percentage of constituent unit (A3) can be determined considering the balance between the required Tg and handleability.

### Examples of the Second Aspect of the Electro-Optic Polymer

### (Examples 2-1 to 2-3)

Electro-optic polymers each having a constituent unit represented by general formula (B1) and a constituent unit represented by general formula (B2) as their backbone (meth)acrylic chain were synthesized. In Examples 2-2 and 2-3, a constituent unit represented by general formula (B3) was also used. The electro-optic structure is a structure made using the molecule of formula (E3) as the electro-optic molecule. The compositions of the electro-optic polymers are presented in Table 2.

X³ in general formula (B1) is —C₂H₄—NCO, and R² is a methyl group.

R³ and R⁴ in general formula (B2) are methyl groups.

R⁶ in general formula (B3) is —COO—C₂H₄—NHCOOCH₃, and R⁵ is a methyl group.

The ratios between constituent units in Table 2 are molar ratios, and
(B1):(B2)=33:67 is intended fora molar ratio (B1):(B2)=1:2;
(B1):(B2):(B3)=25:50:25 is intended for a molar ratio (B1):(B2):(B3)=1:2:1; and
(B1):(B2):(B3)=33:33:33 is intended for a molar ratio (B1):(B2):(B3)=1:1:1.

TABLE 2

| | Blend ratio (molar ratio) between | | | | |
|---|---|---|---|---|---|
| | constituent units | | | Electro-optic | Tg |
| | (B1) | (B2) | (B3) | structure | [° C.] |
| Example 2-1 | 33 | 67 | 0 | E3 | 263 |
| Example 2-2 | 25 | 50 | 25 | E3 | 253 |
| Example 2-3 | 33 | 33 | 33 | E3 | 235 |

The electro-optic polymers synthesized in the Examples all had a high Tg. The lower the percentage of constituent unit (B3), the higher the Tg is. Since a high percentage of constituent unit (B3) makes the electro-optic polymer a material that is easy to handle, the percentage of constituent unit (B3) can be determined considering the balance between the required Tg and handleability.

### Examples of the Third Aspect of the Electro-Optic Polymer

### (Example 3-1)

This example is an example of a method for manufacturing the electro-optic polymer according to the example for (form B).

As the tetracarboxylic acid compound, 4,4′-(hexafluoroisopropylidene)diphthalic dianhydride (6FDA) was prepared.

As the diamine, 5,5′-methylenebis(2-aminobenzoic acid) (MBAA) was prepared.

The electro-optic molecule of formula (E3), which was to give the electro-optic structure, was allowed to react with a pendant COOH group of the MBAA, giving an MBAA with an introduced electro-optic structure at its side chain.

A precursor to the copolymer was produced by allowing the 6FDA and the MBAA with an introduced electro-optic structure to react together. An imidization step followed, causing imide rings to be formed and giving the polyimide chain.

The reaction for the synthesis of the polyimide chain was performed according to the conditions described in Japanese Unexamined Patent Application Publication No. 2019- 174801.

TABLE 3

| | Constituent units blended | | | |
|---|---|---|---|---|
| | Tetracarboxylic | | Electro-optic | Tg |
| | acid compound | Diamine | structure | [° C.] |
| Example 3-1 | 6FDA | MBAA | E3 | 295 |

The electro-optic polymer synthesized in Example 3-1 had a high Tg.

### Examples of the Fourth Aspect of the Electro-Optic Polymer

### (Examples 4-1 to 4-4 and Comparative Example 4-1)

In Examples 4-1 to 4-4, a backbone having at least one triazine ring was synthesized by introducing an electro-optic structure to a cyanate monomer having OCN groups at its ends and polymerizing this cyanate monomer.

In Examples 4-3 and 4-4, an epoxy resin was also added. The electro-optic structure was a structure made using the electro-optic molecule of formula (E3).

In Comparative Example 4-1, a backbone having at least one triazine ring was synthesized by polymerizing a cyanate monomer without introducing an electro-optic structure to it.

The compositions of the electro-optic polymers are presented in Table 4.

The cyanate monomer was a bisphenol cyanate (CYTESTER TA, manufactured by Mitsubishi Gas Chemical Company, Inc.).

The epoxy resin was a biphenyl aralkyl epoxy resin (NC-3000H, manufactured by Nippon Kayaku Co., Ltd.).

The ratios between constituent units in Table 4 are molar ratios, and
(Cyanate monomer):(Electro-optic molecule)=67:33 is intended for a molar ratio (Cyanate monomer):(Electro-optic molecule)=2:1;
(Cyanate monomer):(Electro-optic molecule)=50:50 is intended for a molar ratio (Cyanate monomer):(Electro-optic molecule)=1:1;
(Cyanate monomer):(Electro-optic molecule)(Epoxy resin)=33:33:33 is intended for a molar ratio (Cyanate monomer):(Electro-optic molecule)(Epoxy resin)=1:1:1; and
(Cyanate monomer):(Electro-optic molecule)(Epoxy resin)=25:50:25 is intended for a molar ratio (Cyanate monomer):(Electro-optic molecule)(Epoxy resin)=1:2:1.

TABLE 4

| | Cyanate | Electro-optic | Epoxy | Electro-optic | Tg |
|---|---|---|---|---|---|
| | monomer | molecule | resin | structure | [° C.] |
| Example 4-1 | 67 | 33 | 0 | E3 | 280 |
| Example 4-2 | 50 | 50 | 0 | E3 | 260 |
| Example 4-3 | 33 | 33 | 33 | E3 | 257 |
| Example 4-4 | 25 | 50 | 25 | E3 | 238 |
| Comparative | 100 | 0 | 0 | — | 325 |
| Example 4-1 | | | | | |

The polymer of Comparative Example 4-1, which had no electro-optic structure, had the highest Tg. The Tg tends to decrease with increasing percentage of the electro-optic molecule, but the electro-optic polymers synthesized in the Examples still have a sufficiently high Tg.

### REFERENCE SIGNS LIST

1A Optical multilayer body
10 Support
20 Electro-optic section
21 Cladding layer
21a First cladding layer
21b Second cladding layer
21c Third cladding layer
21d Fourth cladding layer
22 Lower electrode
23 Upper electrode
23a First upper electrode
23b Second upper electrode
24 Electro-optic polymer layer
24a First electro-optic polymer layer
24aa First layer of the first electro-optic polymer layer
24ab Second layer of the first electro-optic polymer layer
24b Second electro-optic polymer layer
24ba First layer of the second electro-optic polymer layer

1. An electro-optic polymer comprising:
a backbone that is a polynorbornene chain; and
an electro-optic structure at a side chain on the backbone,
wherein the polynorbornene chain has a first constituent unit represented by: 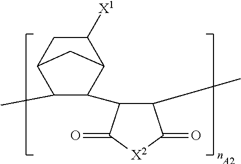
wherein at least one of X¹ or X² is a binding site between the polynorbornene chain and the electro-optic structure,
when X¹ is the binding site, X² is —O— or —NH—,
when X² is the binding site, X¹ is a hydrogen atom or substituted or unsubstituted alkyl group, and
n_{A2} is an integer of 1 or greater.

2. The electro-optic polymer according to claim 1, wherein the binding site is formed by at least one selected from the group consisting of a (thio)ester bond, a (thio)urethane bond, a (thio)urea bond, and a (thio)amide bond.

3. The electro-optic polymer according to claim 1, wherein the electro-optic structure is a structure represented by a donor structure-a bridge structure-an acceptor structure.

4. The electro-optic polymer according to claim 1, wherein the electro-optic structure is a structure represented by: 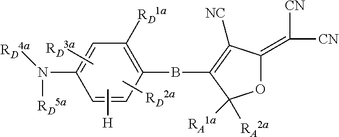
wherein R_{D}^{1a}, R_{D}^{2a}, and R_{D}^{3a} each independently indicate a hydrogen atom, an alkyl group, an alkoxy group, an aryloxy group, an aralkyloxy group, a silyloxy group, an alkenyloxy group, an alkynyloxy group, a hydroxy group, -Rd¹-OH, —ORd²-OH, —OC(═O)Rd³, an amino group, -Rd⁴-NH₂, a thiol group, -Rd⁵-SH, —NCO, or -Rd⁶-NCO,
Rd¹, Rd², Rd³, Rd⁴, Rd⁵, and Rd⁶ are a hydrocarbon group,
at least one of R_{D}^{4a} or R_{D}^{5a} is a structure including a binding site for the backbone and indicates a residue left after an acyloxyalkyl group, a silyloxyalkyl group, -Rd¹-OH, -Rd⁴-NH₂, -Rd⁵-SH, or -Rd⁶-NCO binds with a binding site of the backbone,
of R_{D}^{4a} and R_{D}^{5a}, any structure that is not a binding site for the backbone indicates an alkyl group, a haloalkyl group, an acyloxyalkyl group, a silyloxyalkyl group, -Rd¹-OH, -Rd⁴-NH₂, an aryl group, -Rd⁵-SH, or -Rd⁶-NCO,
B indicates a linking group,
R_{A}^{1a} and R_{A}^{2a} each independently indicate a hydrogen atom, an alkyl group, an alkenyl group, a cycloalkyl group, a cycloalkenyl group, an alkoxy group, a halogenated hydrocarbon group, an aryl group, a hydroxy group, —Ra¹—OH, —ORa²—OH, an amino group, —Ra⁴—NH₂, a thiol group, —Ra⁵—SH, —NCO, or —Ra⁶—NCO, and
Ra¹, Ra², Ra⁴, Ra⁵, and Ra⁶ are a hydrocarbon group.

5. The electro-optic polymer according to claim 1, wherein the polynorbornene chain has a second constituent unit represented by: 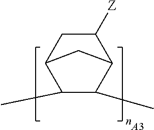
wherein Z is a hydrogen atom or substituted or unsubstituted alkyl group, and
n_{A3} is an integer of 1 or greater.

6. An electro-optic polymer comprising:
a backbone that is a polynorbornene chain; and
an electro-optic structure at a side chain on the backbone,
wherein the polynorbornene chain has a constituent unit represented by: 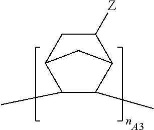
wherein Z is a hydrogen atom or substituted or unsubstituted alkyl group, and n_{A3} is an integer of 1 or greater.

7. The electro-optic polymer according to claim 6, wherein the polynorbornene chain and the electro-optic structure are bound together by at least one binding site formed by at least one selected from the group consisting of a (thio)ester bond, a (thio)urethane bond, a (thio)urea bond, and a (thio)amide bond.

8. The electro-optic polymer according to claim 6, wherein the electro-optic structure is a structure represented by a donor structure-a bridge structure-an acceptor structure.

9. The electro-optic polymer according to claim 6, wherein the electro-optic structure is a structure represented by: 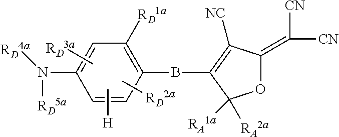
wherein R_{D}^{1a}, R_{D}^{2a}, and R_{D}^{3a} each independently indicate a hydrogen atom, an alkyl group, an alkoxy group, an aryloxy group, an aralkyloxy group, a silyloxy group, an alkenyloxy group, an alkynyloxy group, a hydroxy group, -Rd¹-OH, —ORd²-OH, —OC(═O)Rd³, an amino group, -Rd⁴-NH₂, a thiol group, -Rd⁵-SH, —NCO, or -Rd⁶-NCO,
Rd¹, Rd², Rd³, Rd⁴, Rd⁵, and Rd⁶ are a hydrocarbon group,
at least one of R_{D}^{4a} or R_{D}^{5a} is a structure including a binding site for the backbone and indicates a residue left after an acyloxyalkyl group, a silyloxyalkyl group, -Rd¹-OH, -Rd⁴-NH₂, -Rd⁵-SH, or -Rd⁶-NCO binds with a binding site of the backbone,
of R_{D}^{4a} and R_{D}^{5a}, any structure that is not a binding site for the backbone indicates an alkyl group, a haloalkyl group, an acyloxyalkyl group, a silyloxyalkyl group, -Rd¹-OH, -Rd⁴-NH₂, an aryl group, -Rd⁵-SH, or -Rd⁶-NCO,
B indicates a linking group,
R_{A}^{1a} and R_{A}^{2a} each independently indicate a hydrogen atom, an alkyl group, an alkenyl group, a cycloalkyl group, a cycloalkenyl group, an alkoxy group, a halogenated hydrocarbon group, an aryl group, a hydroxy group, —Ra¹—OH, —ORa²—OH, an amino group, —Ra⁴—NH₂, a thiol group, —Ra⁵—SH, —NCO, or —Ra⁶—NCO, and
Ra¹, Ra², Ra⁴, Ra⁵, and Ra⁶ are a hydrocarbon group.

10. An electro-optic polymer comprising:
a backbone that is at least one (meth)acrylic chain having a first constituent unit and a second constituent unit; and
an electro-optic structure at a side chain on the backbone, wherein
the first constituent unit is represented by: 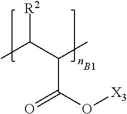
wherein X³ is a binding site between the (meth)acrylic chain and the electro-optic structure,
R² is a hydrogen atom or methyl group, and
n_{B1} is an integer of 1 or greater, and
the second constituent unit is represented by: 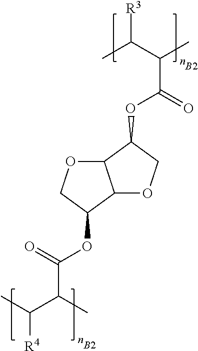
wherein R³ and R⁴ are hydrogen atoms or methyl groups, and
n_{B2} is an integer of 1 or greater.

11. The electro-optic polymer according to claim 10, wherein the binding site is formed by at least one selected from the group consisting of a (thio)ester bond, a (thio)urethane bond, a (thio)urea bond, and a (thio)amide bond.

12. The electro-optic polymer according to claim 10, wherein the electro-optic structure is a structure represented by a donor structure-a bridge structure-an acceptor structure.

13. The electro-optic polymer according to claim 10, wherein the electro-optic structure is a structure represented by: 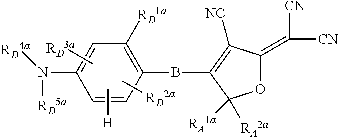
wherein R_{D}^{1a}, R_{D}^{2a}, and R_{D}^{3a} each independently indicate a hydrogen atom, an alkyl group, an alkoxy group, an aryloxy group, an aralkyloxy group, a silyloxy group, an alkenyloxy group, an alkynyloxy group, a hydroxy group, -Rd¹-OH, —ORd²-OH, —OC(═O)Rd³, an amino group, -Rd⁴-NH₂, a thiol group, -Rd⁵-SH, —NCO, or -Rd⁶-NCO,
Rd¹, Rd², Rd³, Rd⁴, Rd⁵, and Rd⁶ are a hydrocarbon group,
at least one of R_{D}^{4a} or R_{D}^{5a} is a structure including a binding site for the backbone and indicates a residue left after an acyloxyalkyl group, a silyloxyalkyl group, -Rd¹-OH, -Rd⁴-NH₂, -Rd⁵-SH, or -Rd⁶-NCO binds with a binding site of the backbone,
of R_{D}^{4a} and R_{D}^{5a}, any structure that is not a binding site for the backbone indicates an alkyl group, a haloalkyl group, an acyloxyalkyl group, a silyloxyalkyl group, -Rd¹-OH, -Rd⁴-NH₂, an aryl group, -Rd⁵-SH, or -Rd⁶-NCO,
B indicates a linking group,
R_{A}^{1a} and R_{A}^{2a} each independently indicate a hydrogen atom, an alkyl group, an alkenyl group, a cycloalkyl group, a cycloalkenyl group, an alkoxy group, a halogenated hydrocarbon group, an aryl group, a hydroxy group, —Ra¹—OH, —ORa²—OH, an amino group, —Ra⁴—NH₂, a thiol group, —Ra⁵—SH, —NCO, or —Ra⁶—NCO, and
Ra¹, Ra², Ra⁴, Ra⁵, and Ra⁶ are a hydrocarbon group.

14. An electro-optic polymer comprising:
a backbone having at least one triazine ring; and
an electro-optic structure at a side chain on the backbone,
wherein the backbone having at least one triazine ring is a structure having a constituent unit represented by: 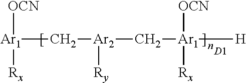
wherein a subset of the OCN ends is at least one binding site for the electro-optic structure,
Ar₂ represents a phenylene, naphthylene, or biphenylene group,
when Ar₂ is a phenylene group, Ari represents a naphthylene or biphenylene group,
when Ar₂ is a naphthylene or biphenylene group, An represents a phenylene, naphthylene, or biphenylene group,
Rₓ is all substituents in Ar₁, each of which independently being an identical group or a different group, and where Rₓ represents a hydrogen, alkyl group, or aryl group,
R_{y} is all substituents in Ar₂, each of which independently being an identical group or a different group, and where R_{y} represents a hydrogen atom, alkyl group, or aryl group, and
n_{D1} is an integer of 1 or greater.

15. The electro-optic polymer according to claim 14, wherein the electro-optic structure is a structure represented by a donor structure-a bridge structure-an acceptor structure.

16. The electro-optic polymer according to claim 14, wherein the electro-optic structure is a structure represented by: 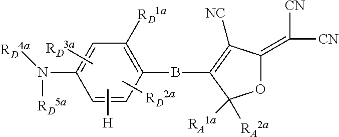
wherein R_{D}^{1a}, R_{D}^{2a}, and R_{D}^{3a} each independently indicate a hydrogen atom, an alkyl group, an alkoxy group, an aryloxy group, an aralkyloxy group, a silyloxy group, an alkenyloxy group, an alkynyloxy group, a hydroxy group, -Rd¹-OH, —ORd²-OH, —OC(═O)Rd³, an amino group, -Rd⁴-NH₂, a thiol group, -Rd⁵-SH, —NCO, or -Rd⁶-NCO,
Rd¹, Rd², Rd³, Rd⁴, Rd⁵, and Rd⁶ are a hydrocarbon group,
at least one of R_{D}^{4a} or R_{D}^{5a} is a structure including a binding site for the backbone and indicates a residue left after an acyloxyalkyl group, a silyloxyalkyl group, -Rd¹-OH, -Rd⁴-NH₂, -Rd⁵-SH, or -Rd⁶-NCO binds with a binding site of the backbone,
of R_{D}^{4a} and R_{D}^{5a}, any structure that is not a binding site for the backbone indicates an alkyl group, a haloalkyl group, an acyloxyalkyl group, a silyloxyalkyl group, -Rd¹-OH, -Rd⁴-NH₂, an aryl group, -Rd⁵-SH, or -Rd⁶-NCO,
B indicates a linking group,
R_{A}^{1a} and R_{A}^{2a} each independently indicate a hydrogen atom, an alkyl group, an alkenyl group, a cycloalkyl group, a cycloalkenyl group, an alkoxy group, a halogenated hydrocarbon group, an aryl group, a hydroxy group, —Ra¹—OH, —ORa²—OH, an amino group, —Ra⁴—NH₂, a thiol group, —Ra⁵—SH, —NCO, or —Ra⁶—NCO, and
Ra¹, Ra², Ra⁴, Ra⁵, and Ra⁶ are a hydrocarbon group.
